(19) United States
(12) Patent Application Publication
(10) Pub. No.: US 2023/0395075 A1
(43) Pub. Date: Dec. 7, 2023

(54) HUMAN-MACHINE DIALOGUE SYSTEM AND METHOD

(71) Applicant: Alibaba Damo (Hangzhou) Technology Co., Ltd., Hangzhou, Zhejiang (CN)

(72) Inventors: Yongbin LI, Beijing (CN); Yuchuan WU, Beijing (CN); Hangyu LI, Beijing (CN); Wentao MA, Beijing (CN); Ting-en LIN, Beijing (CN); Yinpei DAI, Beijing (CN); Jian SUN, Beijing (CN)

(21) Appl. No.: 18/323,641

(22) Filed: May 25, 2023

(30) Foreign Application Priority Data
Jun. 1, 2022 (CN) 202210615940.6

(51) Int. Cl. G10L 15/22; G10L 15/18; G10L 25/63

(52) U.S. Cl. CPC G10L 15/22; G10L 15/1815; G10L 25/63

(57) ABSTRACT

A human-machine dialogue system includes one or more processors configured to execute instructions to cause the human-machine dialogue system to perform operations. The operations include: performing intention clustering of a dialogue data sample based on a semantic representation of the dialogue data sample; constructing, based on a clustering result, a dialogue procedure corresponding to the dialogue data sample; obtaining a semantic representation corresponding to a voice dialogue of a user; performing intention analysis on the semantic representation to obtain an intention analysis result; determining, according to the intention analysis result and the dialogue procedure constructed in advance, a dialogue response; and performing voice interaction of the dialogue response with the user, wherein the dialogue response is an answer response to the voice dialogue, or a clarification response to clarify a dialogue intention of the voice dialogue.

### CROSS-REFERENCE TO RELATED APPLICATIONS

The present application claims priority to and the benefits of Chinese Patent Application Serial No. 202210615940.6, filed on Jun. 1, 2022, which is incorporated herein by reference in its entirety.

### TECHNICAL FIELD

Embodiments of this disclosure relate to the field of human-machine interaction technologies, and in particular, to a human-machine dialogue system and method.

### BACKGROUND

A human-machine dialogue technology is a new form of interaction between humans and machines. Its objective is to enable a machine to understand and use human natural language to implement communication between humans and machines, so that the machine can replace part of work performed by a human brain, and serve as an extension of the human brain.

In the human-machine dialogue technology, a task-oriented human-machine dialogue system is widely used at present. The task-oriented human-machine dialogue system is designed to help users accomplish certain tasks (such as finding products, booking lodging and restaurants). The human-machine dialogue system first understands information given by a human, represents it as an internal state, then selects some actions according to a policy and a dialogue state, and finally converts the actions into a natural language expression form. At present, the human-machine dialogue system is used in many scenarios, from scheduling meetings in daily work to government, finance, education, entertainment, health, and tourism.

However, the conventional task-oriented human-machine dialogue system still has some limitations, including high construction costs and low interaction efficiency due to a one-question-and-one-answer mode. Therefore, how to construct a more intelligent and interactive human-machine dialogue system at lower costs becomes an urgent problem to be solved.

### SUMMARY

Embodiments of the present disclosure provide a human-machine dialogue system. The human-machine dialogue system includes one or more processors configured to execute instructions to cause the human-machine dialogue system to perform operations. The operations include: performing intention clustering of a dialogue data sample based on a semantic representation of the dialogue data sample; constructing, based on a clustering result, a dialogue procedure corresponding to the dialogue data sample; obtaining a semantic representation corresponding to a voice dialogue of a user; performing intention analysis on the semantic representation to obtain an intention analysis result; determining, according to the intention analysis result and the dialogue procedure constructed in advance, a dialogue response; and performing voice interaction of the dialogue response with the user, wherein the dialogue response is an answer response to the voice dialogue, or a clarification response to clarify a dialogue intention of the voice dialogue.

Embodiments of the present disclosure provide a human-machine dialogue system. The human-machine dialogue system includes one or more processors configured to execute instructions to cause the human-machine dialogue system to perform operations. The operations include: performing semi-supervised training on a pre-training dialogue model by using obtained dialogue data sample as a training sample of the pre-training dialogue model, to obtain a model capable of outputting a semantic representation corresponding to the dialogue data sample, wherein each dialogue data sample includes multiple turns of dialogue data, and each turn of the dialogue data includes role information and turn information; performing intention clustering on the dialogue data sample based on the semantic representation; performing dialogue procedure mining based on a result of the intention clustering; constructing, based on a mining result, a dialogue procedure corresponding to the dialogue data sample; training a second machine learning model based on the semantic representation, so as to obtain a model capable of making a dialogue response; and separately training a voice recognition model and a voice conversion model to obtain a corresponding model capable of performing voice recognition and a corresponding model for performing text-to-voice conversion.

Embodiments of the present disclosure provide a non-transitory computer-readable storage medium storing a set of instructions that are executable by one or more processors of a device to cause the device to perform a human-machine dialogue method. The human-machine dialogue method includes operations including: receiving a voice dialogue from a user; converting the voice dialogue into a dialogue text; obtaining a semantic representation of the dialogue text; performing intention analysis on the semantic representation; determining a dialogue response according to an intention analysis result and a dialogue procedure constructed in advance, wherein the dialogue procedure is constructed by using an intention clustering result obtained after intention clustering is performed in advance based on a semantic representation of a dialogue data sample, and the dialogue response is an answer response to the voice dialogue, or a clarification response to clarify a dialogue intention of the voice dialogue; and converting the dialogue response into voice, so as to interact with the user by the voice.

It should be understood that the above general descriptions and the following detailed descriptions are merely for exemplary and explanatory purposes, and do not limit the present disclosure.

### BRIEF DESCRIPTION OF THE DRAWINGS

To describe the technical solutions in the embodiments of the present disclosure or in the existing technology more clearly, the following briefly introduces the accompanying drawings needed for describing the embodiments or the existing technology. Clearly, the accompanying drawings in the following description merely show some embodiments recorded in the present disclosure, and a person of ordinary skill in the art can still derive other drawings from these accompanying drawings without creative efforts.

FIG. 1 is a schematic diagram of an example system applicable to a human-machine dialogue solution, according to some embodiments of the present disclosure.

FIG. 2A is a structural block diagram of an example human-machine dialogue system, according to some embodiments of the present disclosure.

FIG. 2B is an example diagram of a scenario of performing a human-machine dialogue using a human-machine dialogue system of FIG. 2A, according to some embodiments of the present disclosure.

FIG. 3A is a schematic structural diagram of an example human-machine dialogue system, according to some embodiments of the present disclosure.

FIG. 3B is a schematic diagram of a pre-training dialogue model in the embodiments of FIG. 3A, according to some embodiments of the present disclosure.

FIG. 3C is a schematic diagram of constructing a dialogue procedure in the embodiments of FIG. 3A, according to some embodiments of the present disclosure.

FIG. 3D is a schematic diagram of a dialogue data extension in the embodiments of FIG. 3A, according to some embodiments of the present disclosure.

FIG. 3E is a schematic diagram of a second machine learning model in the embodiments of FIG. 3A, according to some embodiments of the present disclosure.

FIG. 3F is a schematic diagram of a DST model in the embodiments of FIG. 3A, according to some embodiments of the present disclosure.

FIG. 3G is a schematic diagram of a policy prediction model in the embodiments of FIG. 3A, according to some embodiments of the present disclosure.

FIG. 4 is a flowchart of an example human-machine dialogue method, according to some embodiments of the present disclosure.

FIG. 5 is a schematic structural diagram of an example electronic device, according to some embodiments of the present disclosure.

### DETAILED DESCRIPTION

To make a person skilled in the art understand the technical solutions in the embodiments of the present disclosure better, the following clearly and comprehensively describes the technical solutions in the embodiments of the present disclosure with reference to the accompanying drawings in the embodiments of the present disclosure. Clearly, the described embodiments are merely some but not all of the embodiments of the present disclosure. All other embodiments obtained by a person of ordinary skill in the art based on the embodiments in the present disclosure shall fall within the protection scope of the embodiments of the present disclosure.

The following further describes specific implementation of the embodiments of the present disclosure with reference to the accompanying drawings of the embodiments of the present disclosure.

According to the human-machine dialogue solution provided in the embodiments of the present disclosure, for human-machine interaction in various fields and industries, a dialogue procedure of a human-machine dialogue that meets an actual requirement may be constructed in advance offline by using a dialogue construction layer. In a subsequent online use phase, an intention of the user may be determined by using a dialogue engine layer based on a semantic representation corresponding to a received user voice dialogue. A corresponding dialogue response is provided with reference to a dialogue procedure constructed by using the dialogue construction layer, and then human-machine dialogue interaction is implemented by using a voice interaction layer. It can be learned that the human-machine dialogue system in the embodiments of the present disclosure may be widely used in various scenarios. A dialogue procedure in various scenarios may be constructed by offline processing of the dialogue construction layer, which reduces the construction cost of the human-machine dialogue system and expands an applicable scope of the human-machine dialogue system. In addition, compared with a conventional one-question-to-one-answer human-machine dialogue interaction form, in a case where the system fails to obtain the user intention based on the current dialogue, the human-machine dialogue system in the embodiments of the present disclosure may further continue the dialogue based on the current dialogue and the user's original dialogue intention. That is, the dialogue can be continued by using a clarification response, so as to accurately determine the user intention according to a complete dialogue formed by the original dialogue and the continuous dialogue, and provide an accurate dialogue response. In addition, the user does not need to repeat the previous dialogue or restart the dialogue, which improves the efficiency of human-machine dialogue interaction, and improves the user experience.

FIG. 1 shows an example system applicable to a human-machine dialogue solution, according to some embodiments of the present disclosure. As shown in FIG. 1, the system 100 may include a server 102, a communication network 104, and/or one or more user devices 106. In the example of FIG. 1, there are multiple user devices.

The server 102 may be any suitable server configured to store information, data, programs, and/or any other suitable type of content. In some embodiments, the server 102 may perform any suitable function. For example, in some embodiments, the server 102 may be provided with a human-machine dialogue system. In some embodiments, the human-machine dialogue system includes a dialogue construction layer, a dialogue engine layer, and a voice interaction layer. The human-machine dialogue system constructs a dialogue procedure of a corresponding industry or service offline in advance through the dialogue construction layer. The dialogue engine layer analyzes a voice-converted text dialogue of the user online, and determines a dialogue response based on a dialogue intention of the dialogue and the dialogue procedure constructed in advance. The dialogue response may be an answer response determined on the basis that the dialogue intention is directly obtained from the dialogue, or may be a clarification response that, in a case where the dialogue intention is not explicitly obtained from the dialogue, follows up with the user continuously based on the semantic of the original dialogue to clarify the dialogue intention. The voice interaction layer performs voice dialogue with the user, including playing a dialogue response to the user. In an optional example, in some embodiments, the server 102 may execute corresponding instruction(s) by the processor(s), so as to invoke the human-machine dialogue system to perform the corresponding human-machine dialogue method. As another example, in some embodiments, the server 102 may convert the dialogue response into voice, and then send the voice response to the user device, and receive voice dialogue data of the user sent from the user device.

In some embodiments, the communication network 104 may be any suitable combination of one or more wired and/or wireless networks. For example, the communication network 104 may include any one or more of the following: the Internet, an intranet, a wide area network (WAN), a local area network (LAN), a wireless network, a digital subscriber line (DSL) network, a frame relay network, an asynchronous transfer mode (ATM) network, a virtual private network (VPN), and/or any other suitable communication network. The user device 106 can be connected to the communication network 104 via one or more communication links (e.g., a communication link 112), which can be connected to the server 102 via one or more communication links (e.g., a communication link 114). The communication link may be any communication link suitable for transmitting data between the user device 106 and the server 102, such as a network link, a dial-up link, a wireless link, a hard-wired link, any other suitable communication link, or any suitable combination of such links.

The user device 106 may include any one or more user devices adapted to perform human-machine voice dialogue interaction. In some embodiments, the user device 106 may include any suitable type of device. For example, in some embodiments, the user device 106 may include a mobile device, a tablet computer, a laptop computer, a desktop computer, a wearable computer, a game console, a media player, a vehicle entertainment system, and/or any other suitable type of user device.

Although the server 102 is illustrated as one device, in some embodiments, any suitable quantity of devices may be used to perform the functions performed by the server 102. For example, in some embodiments, multiple devices may be used to implement functions performed by the server 102. Alternatively, a cloud service may be used to implement a function of the server 102.

The human-machine dialogue system in the embodiments of the present disclosure may be widely applied to various human-machine dialogue scenarios, especially a dialogue scenario with a dialogue procedure logic. When applied to a dialogue scenario with a dialogue procedure logic, a corresponding dialogue procedure may be constructed by using the dialogue construction layer, which greatly facilitates implementation of dialogue interaction in this scenario, enables an intelligent machine to provide an accurate dialogue response based on the dialogue procedure, and completes a task of a task-oriented dialogue.

Based on the foregoing system, some embodiments of the present disclosure provide a human-machine dialogue solution, which is described by using various embodiments in the following.

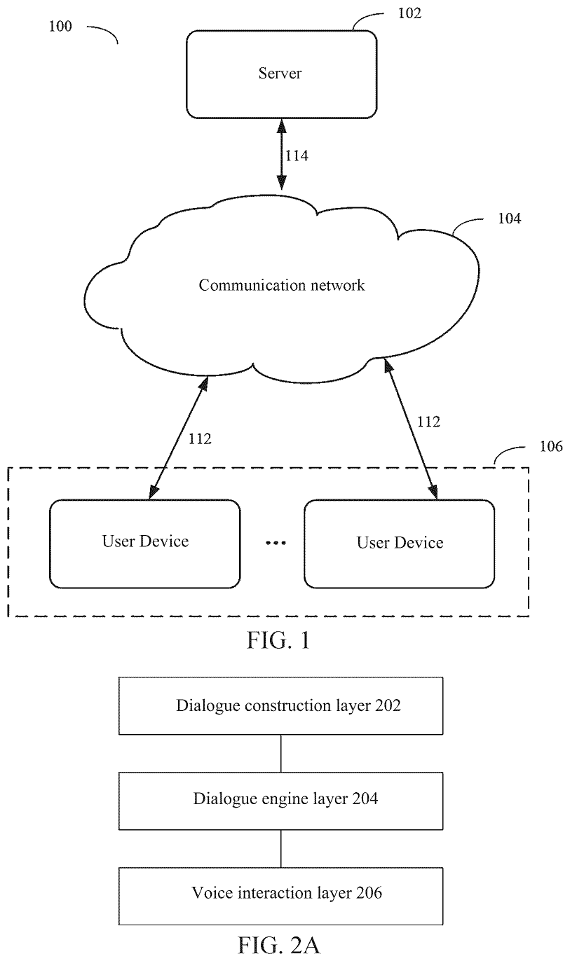

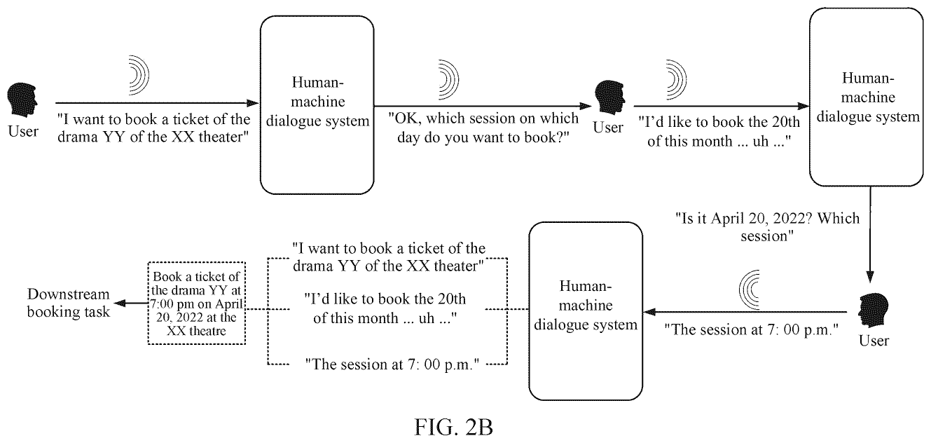

In some embodiments, the human-machine dialogue system is described from an application perspective in an actual application scenario. Referring to FIG. 2A, FIG. 2A is a structural block diagram of a human-machine dialogue system according to some embodiments of the present disclosure.

As can be seen from FIG. 2A, the human-machine dialogue system includes a dialogue construction layer 202, a dialogue engine layer 204, and a voice interaction layer 206.

The dialogue construction layer 202 is configured to perform intention clustering of a dialogue data sample in advance based on a semantic representation of the dialogue data sample, and construct, based on a clustering result, a dialogue procedure corresponding to the dialogue data sample. The dialogue data sample is generally collected and obtained according to a requirement of an actual application scenario. For example, if the scenario is an e-commerce scenario, the dialogue data sample may be a dialogue between a buyer and a robot client service in such scenario. If the scenario is an online medical scenario, the dialogue data sample may be a dialogue between a patient and a robot doctor in such scenario. If the scenario is an online financial scenario, the dialogue data sample may be a dialogue between the user and the robot client service in such scenario, and so on.

The dialogue engine layer 204 is configured to obtain a semantic representation corresponding to a voice dialogue of a user received by the voice interaction layer 206, and perform intention analysis on the semantic representation to obtain an intention analysis result. The dialogue engine layer 204 is further configured to determine a dialogue response according to the intention analysis result and the dialogue procedure constructed in advance by the dialogue construction layer 202, and perform voice interaction of the dialogue response with the user by the voice interaction layer 206. The dialogue response may be an answer response to the foregoing voice dialogue, or may be a clarification response to clarify a dialogue intention of the foregoing voice dialogue. In some cases, the voice dialogue of the user has an explicit intention, and the corresponding intention may be directly obtained according to the voice dialogue of the user. Further, according to the intention, a dialogue response is determined based on a dialogue procedure constructed in advance by the dialogue construction layer 202. In such cases, the response is an answer response. However, in some cases, the voice dialogue of the user does not clearly indicate the intention or the intention of the user is incomplete, and it is necessary to determine, according to the semantic representation corresponding to the voice dialogue, to perform another dialogue with the user to clarify the intention of the user. In such cases, the determined dialogue response is a clarification response. By using the clarification response, another interaction with the user can be performed to obtain another voice dialogue. Then the intention of the user is determined based on the another voice dialogue and the original dialogue. Then, the dialogue response is determined based on the dialogue procedure constructed in advance by the dialogue construction layer 202 according to the determined intention.

The voice interaction layer 206 is mainly configured to perform voice interaction with the user and conversion between voice data and text data. For example, the voice interaction layer 206 may receive the voice dialogue of the user and convert the voice dialogue into a dialogue text, and convert a dialogue response in the form of a text into voice to interact with the user through the voice.

In a human-machine dialogue scenario, the user often interacts with an intelligent machine (e.g., an intelligent dialogue robot) by using voice. In a task-oriented human-machine dialogue, a specific task (e.g., tasks of withdrawing provident fund, booking a flight ticket, making a hotel reservation, etc.) needs to be completed by multiple turns of human-machine dialogues. In such cases, an intelligent machine having a human-machine dialogue system not only needs to determine and reply to the user's question based on the dialogue procedure constructed in advance, but also needs to be able to handle dialogue situations that fall outside of the dialogue procedure constructed in advance. For example, when the intelligent machine does not understand what the user said, active interactions beyond the dialogue procedure can be performed to generate a clarification response to clarify the user's dialogue intention and guide the dialogue to proceed effectively, thereby finally determining the user's intention. Based on the above, the human-machine dialogue system in some embodiments of the present disclosure may implement corresponding functions by the dialogue engine layer, so as to generate an answer response or a clarification response that can interact with the user.

The dialogue procedure is constructed and completed offline by the dialogue construction layer 202 in advance. In a feasible manner, when constructing the dialogue procedure, the dialogue construction layer 202 may perform processing including intention clustering based on the semantic representation of the dialogue and the dialogue data itself, and automatically construct and generate the dialogue procedure after performing process such as dialogue procedure mining based on the intention clustering result. For example, the dialogue construction layer 202 may perform dialogue semantic cluster segmentation on the dialogue data sample in advance based on the semantic representation of the dialogue data sample, perform hierarchical density clustering according to a semantic cluster obtained by segmentation and a dialogue representation vector corresponding to the dialogue data sample, and obtain, according to the clustering result, at least one start intention and dialogue data corresponding to each start intention. The dialogue construction layer 202 may further, for each start intention, perform dialogue path mining based on dialogue data corresponding to the start intention, and construct, according to a mining result, a dialogue procedure corresponding to the dialogue data sample. Optionally, when the dialogue procedure corresponding to the dialogue data sample is constructed according to the mining result, the dialogue construction layer 202 may obtain, according to the mining result, dialogue semantic clusters that are respectively corresponding to a user and a robot customer service corresponding to the dialogue data, construct a key dialogue transfer matrix according to the dialogue semantic clusters respectively corresponding to the user and the robot customer service, and generate, according to the key dialogue transfer matrix, a dialogue path used to indicate a dialogue procedure, and mount the generated dialogue path to the start intention to construct the dialogue procedure corresponding to the dialogue data sample. The start intention means an intention when a dialogue is started for substantive content expression. An example dialogue may be: “Customer service: XXX, hello, I am the customer service of XXX. User: Hello. Customer service: I noticed that you've reserved a standard room at the XXX hotel, but the payment hasn't been made yet. If you still require the room, please make the payment as soon as possible. User: Which hotel are you referring to?” As can be seen from the above dialogue, the intention corresponding to “I noticed that you've reserved a standard room at the XXX hotel, but the payment hasn't been made yet. If you still require the room, please make the payment as soon as possible” is confirmed as a start intention. However, a person skilled in the art should understand that in actual application, the start intention may also be triggered by the user. A specific generation process of the dialogue procedure in this manner will be further described in detail below, and details are not described herein for brevity. In another feasible manner, when constructing the dialogue procedure, the human-machine dialogue system can provide a corresponding construction interface, and provide an optional process construction control (e.g., a text input control, a connection control, an option control, etc.) in the construction interface. The process constructor manually constructs the dialogue procedure by using these controls.

Because the voice interaction layer 206 handles the tasks of interacting with the user, after the dialogue engine layer 204 determines the dialogue response, the voice interaction layer 206 converts the dialogue response into voice of the dialogue response, so as to interact with the user by the voice.

In addition, optionally, in order to make interactions with the intelligent machines more natural, smooth, and similar to human-to-human interactions, and to improve the user's human-machine interaction experience, in an optional solution, the voice interaction layer 206 is further configured to, in the process of performing dialogue interaction with the user, perform at least one of the following operations: detecting whether an insertion timing for a set speech exists, and inserting a set speech when detecting the insertion timing; in a process of performing voice dialogue interaction with the user, detecting an inserted voice by the user, and in response to determining that an intention corresponding to the inserted voice is to interrupt a dialogue voice, processing the inserted voice; or detecting a pause of the user in a dialogue interaction process, and in response to a detection result indicating that a dialogue corresponding to the pause is incomplete, inserting a guide language to guide the user to complete the dialogue.

The set speech may be an acknowledgement word, such as, “um,” “ah,” “oh,” etc. By inserting the set speech, the human-machine interaction can be more natural and smooth, to create a feeling of interacting with a real human for the user.

In addition, in some dialogue procedures, the inserted voice of the user may be detected before the dialogue played by the intelligent machine is finished. In such cases, on one hand, the intention of the inserted voice may be detected, so as to avoid that the inserted voice without an interrupt intention affects normal interactions and to improve the user experience. On the other hand, if an interrupt intention is determined, timely processing may be performed, instead of continuing playing a dialogue response in a conventional manner that causes a failure to process an interaction requirement of the user in a timely manner, affecting the user experience.

In an actual dialogue scenario, the user may pause during a dialogue for various reasons such as taking time to think or experiencing interference. Pause detection can be used to determine whether the dialogue of the user is completed, which can improve the user experience, enhance the intelligence of the human-machine dialogue system, and obtain a complete dialogue, so as to improve the efficiency and accuracy of subsequent processing of the dialogue.

It can be learned that, the foregoing manner can enable the human-machine dialogue system to be more intelligent and more similar to realistic human interaction, and improve the user interaction experience.

According to some embodiments, for human-machine interaction in various fields and industries, a dialogue procedure of a human-machine dialogue that meets an actual requirement may be constructed in advance offline by using a dialogue construction layer. In a subsequent online use phase, an intention of the user may be determined by using a dialogue engine layer based on a semantic representation corresponding to a received user voice dialogue. A corresponding dialogue response is provided with reference to a dialogue procedure constructed by using the dialogue construction layer, and then human-machine dialogue interaction is implemented by using a voice interaction layer. It can be learned that the human-machine dialogue system in the embodiments may be widely used in various scenarios. A dialogue procedure in various scenarios may be constructed by offline processing of the dialogue construction layer, which reduces the construction cost of the human-machine dialogue system and expands an applicable scope of the human-machine dialogue system. In addition, compared with a conventional one-question-to-one-answer human-machine dialogue interaction form, in a case where the system fails to obtain the user intention based on the current dialogue, the human-machine dialogue system may further continue the dialogue based on the current dialogue and the user's original dialogue intention. That is, the dialogue can be continued by using a clarification response, so as to accurately determine the user intention according to a complete dialogue formed by the original dialogue and the continuous dialogue, and provide an accurate dialogue response. In addition, the user does not need to repeat the previous dialogue or restart the dialogue, which improves efficiency of human-machine dialogue interaction, and improves user experience.

An example of the foregoing process is described below by using a specific example, as shown in FIG. 2B.

Assuming that in a dialogue, the user sends voice “I want to book a ticket of the drama YY of the XX theater,” and a user-end device sends the voice to the human-machine dialogue system, then, the human-machine dialogue system converts the voice into a text by using the voice interaction layer, and then passes the text to the dialogue engine layer to obtain a corresponding semantic representation. Then, the human-machine dialogue system determines, according to the semantic representation, whether a complete intention of the dialogue can be understood. In this dialogue, the user clearly expresses the intention, and the dialogue engine layer may accurately obtain the intention of the dialogue based on key information in the dialogue (which may also be considered as slot information), such as “XX theater,” “drama YY,” and “ticket.” Further, a corresponding process node is determined from the dialogue procedure constructed in advance corresponding to the dialogue according to the intention. Then, a subsequent process node may be determined according to the process node. For example, assuming that the process node instructs to collect a specific performance time, the dialogue engine layer of the human-machine dialogue system generates a corresponding dialogue response based on information indicated by the process node, for example, “OK, which session on which day do you want to book?” The voice interaction layer converts the dialogue response into voice, and then sends the voice response to the user-end device, and the voice response to the user is played by the user-end device.

If the user, after hearing the response, sends voice “I'd like to book the 20th of this month . . . uh . . . ,” after the voice is sent to the human-machine dialogue system and converted into a text, the dialogue engine layer obtains a corresponding semantic representation again. When analyzing the dialogue intention based on the semantic representation, it is considered that the dialogue is incomplete, and the intention of the dialogue cannot be accurately obtained. Then, to clarify the intention of the dialogue, a corresponding dialogue response (clarification response) will be generated, for example, “Is it Apr. 20, 2022? Which session?” The dialogue response is still converted into voice, and is sent to the user-end device for playing.

Assuming that the user sends voice “the session at 7:00 p.m,” after hearing the response, similar to the foregoing processing process, the voice is converted into a dialogue text, and a corresponding semantic representation is generated. In this case, the dialogue engine layer will combine the previous dialogue and the current dialogue to determine that the complete information is “book the session at 7:00 p.m. on Apr. 20, 2022.” Further, in combination with the start dialogue of the user, that is, “I want to book a ticket of the drama YY of the XX theater,” it is determined that the user intends to book a ticket of the drama YY of the XX theater at 7:00 p.m. on Apr. 20, 2022. Based on this, the information of the intention is processed by a corresponding downstream task to ultimately assist the user to complete the ticket order.

Certainly, the foregoing example is only a simple example for illustration purposes. In an actual application, the dialogue interaction is more complex, and there may be more dialogues with incomplete or unclear intentions, which may be processed based on the human-machine dialogue system provided in the embodiments of the present disclosure.

It can be learned from this example that the human-machine dialogue system in the embodiments of the present disclosure can be effectively applied to various human-machine dialogue scenarios, in particular a task-oriented human-machine dialogue scenario, to interact with a user, so as to achieve the user's intention and implement a better interaction effect.

In some embodiments of the present disclosure, the human-machine dialogue system is described from the perspective of the overall training process before using the human-machine dialogue system.

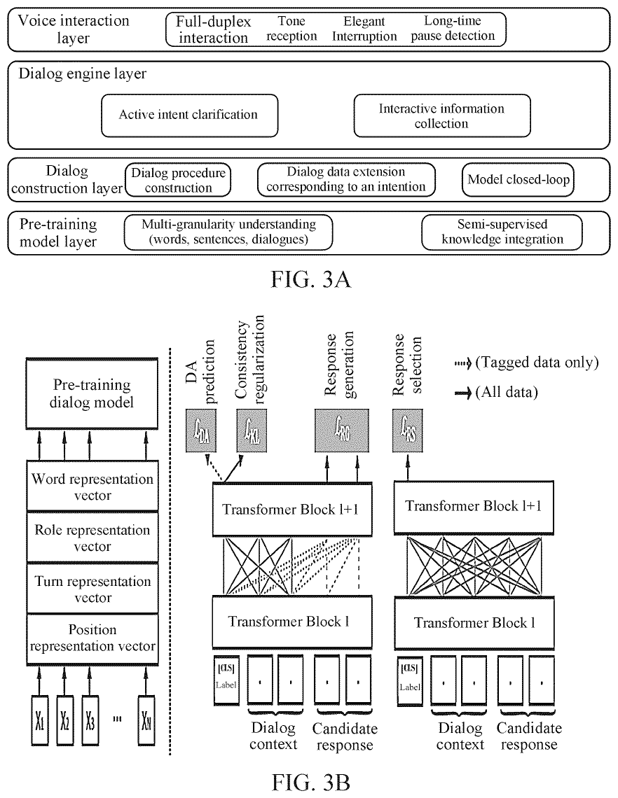

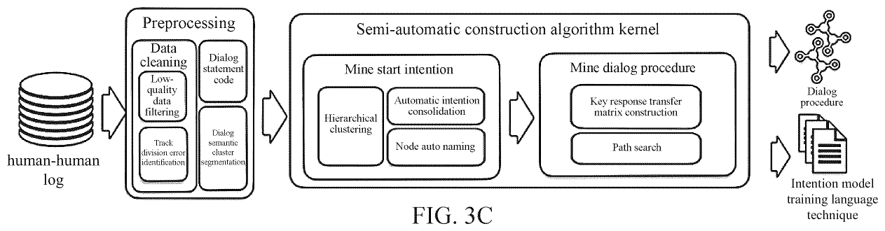

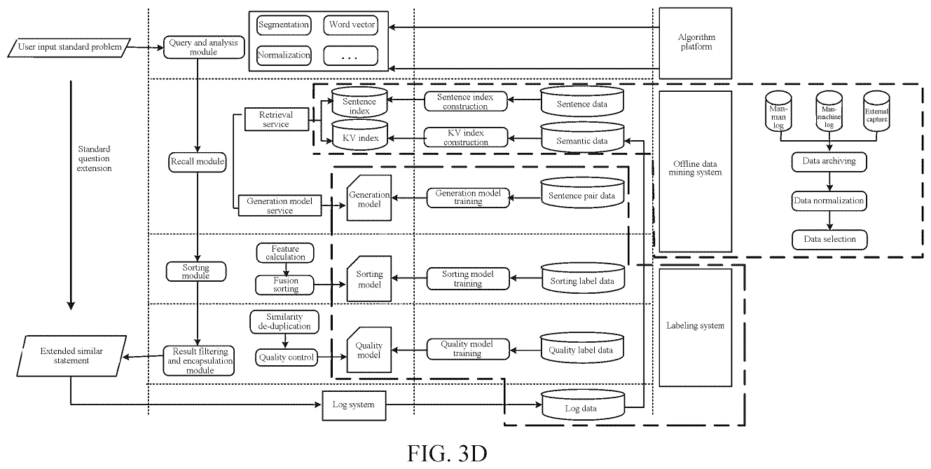

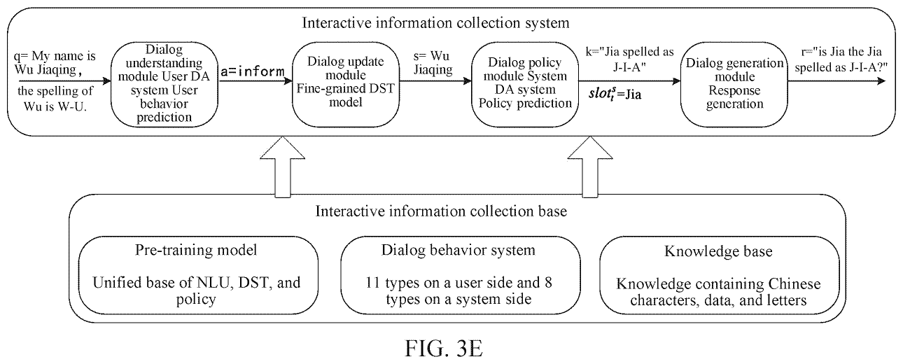

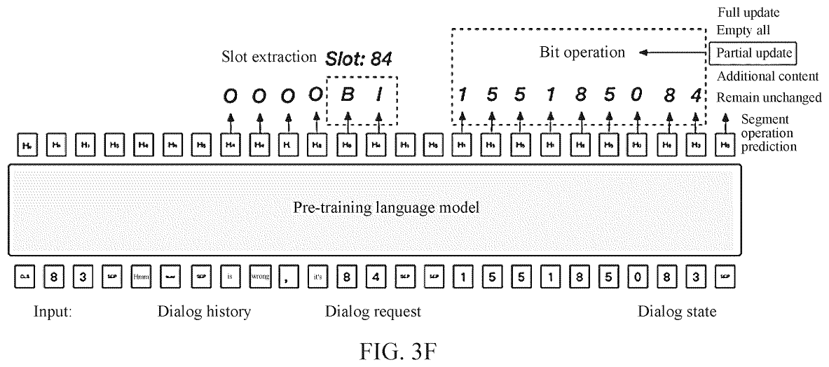

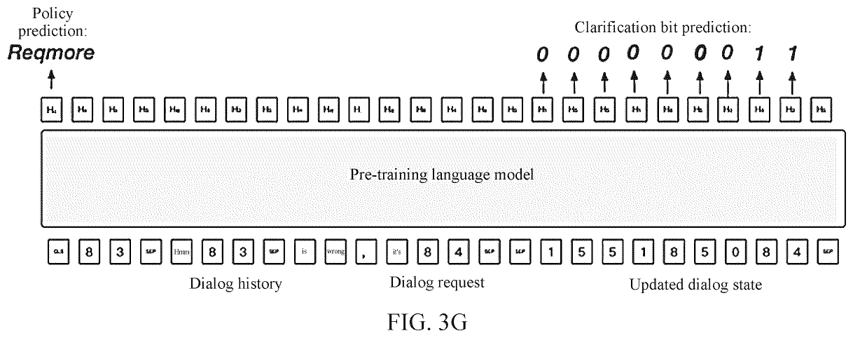

FIG. 3A is a schematic structural diagram of a human-machine dialogue system, according to some embodiments of the present disclosure.

As can be seen from the figure, the human-machine dialogue system has a pre-training model layer, a dialogue construction layer, a dialogue engine layer, and a voice interaction layer.

In the whole training process of the human-machine dialogue system, the pre-training model layer performs semi-supervised training on a pre-training dialogue model by using obtained dialogue data sample as a training sample of the pre-training dialogue model, to obtain a model capable of outputting a semantic representation corresponding to the dialogue data sample. Each dialogue data sample includes multiple turns of dialogue data, and each turn of dialogue data includes role information and turn information. The dialogue construction layer performs intention clustering on the dialogue data sample based on the semantic representation outputted by the pre-training model layer, performs dialogue procedure mining based on a result of the intention clustering, and constructs, based on a mining result, a dialogue procedure corresponding to the dialogue data sample. The dialogue engine layer trains a second machine learning model of the dialogue engine layer based on the semantic representation outputted by the pre-training model layer, so as to obtain a model capable of making a dialogue response. The voice interaction layer is configured to separately train a voice recognition model and a voice conversion model to obtain a corresponding model capable of performing voice recognition and a corresponding model for performing text-to-voice conversion. It should be noted that a voice recognition model completed by the training at the voice interaction layer may perform voice recognition on the voice dialogue data, so as to obtain the dialogue sample data to be sent to the pre-training model layer as a training sample of the pre-training dialogue model, but is not limited thereto. The training sample used at the pre-training model layer may also be a directly collected dialogue text. The voice interaction layer may train the voice conversion model by using the dialogue response output from the model of the dialogue engine layer, but is not limited thereto. The voice interaction layer may also collect other dialogue texts to train the voice conversion model. In addition, it should be further noted that the voice interaction layer in the embodiments of the present disclosure may be implemented in a conventional automatic speech recognition and text-to-speech synthesis (ASR+TTS) manner. However, to make the effect of the human-machine dialogue interaction better and smarter, the voice interaction layer in the embodiments of the present disclosure further uses a full-duplex interaction mode based on the ASR+TTS, and obtains the machine learning model by the training based on the mode.

The foregoing training processes of each part of the foregoing human-machine dialogue system will be separately described below.

First, regarding the pre-training model layer, in this layer, a pre-training dialogue model is an important part of implementing a function of the pre-training model layer. Different from a conventional pre-training language model, in the embodiments of the present disclosure, a semi-supervised training manner is used to train the model. In addition, the input of the model takes into account the dialogue turn information and the role information in a case of multiple turns of dialogues.

A detailed explanation is provided below. In a task-based human-machine dialogue system, the dialogue policy is an important part. It can determine the quality of a response statement given by the system in the multi-turn interaction with the user, thus affecting the user's interaction experience. The dialogue policy is generally described by using a dialogue act (Dialogue Act, DA) tag. This is a specific dialogue labeling knowledge. When given dialogue history of both parties, the dialogue policy needs to select the correct dialogue act to instruct the dialogue generation. However, high-quality tagged data is very limited because of high cost and complexity of labeling, and there is a problem of inconsistent definitions in different data sets, which is very different from the large-scale untagged corpus that is easy to obtain on the network. To train the pre-training dialogue model that can accurately understand a dialogue semantic and select a dialogue policy, the adequacy of the training data is a prerequisite for the implementation of the pre-training dialogue model. Based on this, in the embodiments of the present disclosure, some of the dialogue data samples for training the pre-training dialogue model are tagged data, and the other samples are untagged data, so as to expand the sample data volume. At the same time, two conventional pre-training paradigms, supervised pre-training and unsupervised pre-training, do not meet the model training in the case of this training sample. Therefore, in the embodiments of the present disclosure, in the semi-supervised training manner, supervised optimization is performed on tagged data, while inference is performed on untagged data, and constraint optimization is performed according to a prediction result.

In an implementation, the pre-training model layer performs semi-supervised training on the pre-training dialogue model by using the obtained dialogue data sample as the training sample of the pre-training dialogue model may be implemented by: determining a representation vector corresponding to each turn of the dialogue data of the dialogue data sample, where the representation vector includes a word representation vector, a role representation vector, a turn representation vector, and a position representation vector, and performing the semi-supervised training on the pre-training dialogue model based on a preset semi-supervised loss function by using representation vectors respectively corresponding to multiple turns of the dialogue data in each dialogue data sample as an input, where the semi-supervised loss function includes a first sub-loss function for the tagged data and a second sub-loss function for the untagged data. Optionally, the first sub-loss function is generated based on a loss function for a dialogue response selection task, a loss function for a dialogue response generation task, a loss function for dialogue action prediction, and a bi-directional KL regularization loss function. The second sub-loss function is generated based on the loss function for the dialogue response selection task, the loss function for the dialogue response generation task, and a bi-directional KL regularization loss function with a gate mechanism.

For example, a schematic training diagram of the pre-training dialogue model is shown in FIG. 3B. It can be learned from the figure that the pre-training dialogue model in this example is implemented based on a transformer structure, but a person skilled in the art should understand that a machine learning model in another encoder+decoder form is also applicable to this example solution.

The left part of the dotted line in FIG. 3B shows that, for a dialogue data sample (including tagged and untagged, in which in the figure, X1, X2, . . . , and XN are used to indicate the dialogue data sample including multiple turns of dialogue data), corresponding role representation vectors (Role Embedding) and turn representation vectors (Turn Embedding) are separately obtained based on the word representation vector (Token Embedding) and the position representation vector (Position Embedding) obtained corresponding to the dialogue data, and further based on role information (used to represent a role corresponding to a turn of dialogue, such as a customer service and a user) and turn information (used to represent a turn in the dialogue data to which the turn of dialogue belongs, and for example, in one dialogue data sample including three dialogues A, B, and C, the corresponding turns being the first turn, the second turn, and the third turn respectively). These representation vectors are input into a pre-training dialogue model including multiple transformer blocks for the training.

The training objective of the pre-training dialogue model includes both conventional modeling dialogue understanding and self-supervision loss generated by the dialogue, as well as the semi-supervision loss of the modeling dialogue policy, as shown in the right part of the dotted line in FIG. 3B.

For the dialogue understanding part, a response selection is used as a training target (as shown in the right half of the right part of the dotted line in FIG. 3B). That is, given a dialogue context and a candidate response, whether the response is correct is determined by performing a binary decision at the [CLS] position. [CLS] refers to the classification, which may be understood as a classification task for the downstream. It should be noted that, in the embodiments of the present disclosure, the classification task is a statement pair (context, response) classification task. For this task, in addition to adding the [CLS] tag symbol and using the corresponding output as the semantic representation of the text, the model divides the input two sentences by using one [SEP] symbol and adds two different text vectors respectively to distinguish between the two sentences. For example, a text vector of a common input dialogue context and a text vector of a candidate response are distinguished by using a [CLS] symbol. A loss function corresponding to this part is denoted as [symbol] _{RS} and is specifically represented as follows:

[symbol]

_{RS}=−log p(l=1|c,r)−log p(l=0|c,r⁻),

where c denotes a context, r denotes a response positive sample, r⁻ denotes a response negative sample, and p(l|c, r) denotes a classification probability.

For the dialogue generation part, a regular response generation target is used. That is, given a dialogue context, a correct response statement is generated (as shown in the left half of the right part of the dotted line in FIG. 3B). A loss function corresponding to this part is denoted as [symbol] _{RG} and is specifically represented as follows:

$${ℒ}_{R G} = - {\sum }_{t = 1}^{T} log p ( {r}_{t} \vert c , {r}_{< t} )$$

The loss function is a standard negative logarithmic likelihood function, where c represents a context, r represents a response, rₜ represents a t-th word in r, T represents a total quantity of words in r, and r_{<t}={r₁, . . . , rₜ₋₁}.

For the dialogue policy part, in the embodiments of the present disclosure, a highly efficient consistency regularization method in the semi-supervised learning is used to model the dialogue action. For the CR method, assuming that a low-density assumption is satisfied (i.e., the classification boundary is in a low-density distribution), after the perturbation on the same sample, the classification result still possesses a certain degree of consistency. That is, the distributions are close or the prediction results are close (the predicted classification result before the perturbation is close to the predicted classification result after the perturbation). Then, the final semi-supervised learning based on the consistency regularization ensures that the correct classification surface can be found.

The specific loss function composition for the dialogue policy part is as follows.

For the untagged dialogue data, the idea of R-drop is used. That is, given the same dialogue input c, two times of the forward propagation with dropout are used to obtain two different distributions q1 (aκ) and q2 (aκ) that are predicted in the dialogue action space after random disturbance, and then two distributions are constrained by using a bidirectional KL regularization loss function. R-Drop means that in the same step, the forward propagation is performed twice for the same sample. Because the dropout exists, two different but very similar probability distributions are obtained. By adding the KL divergence loss of the two distributions to the original cross-entropy loss, the reverse propagation and the parameter update are performed together. The term dropout means that in a training process of a deep learning network, a neural network unit is temporarily discarded from the network according to a specific probability.

The foregoing bi-directional KL regularization loss function may be represented as:

$${ℒ}_{K L} = \frac{1}{2} ( {D}_{K L} ( {q}_{1} \vert \vert {q}_{2} ) + {D}_{K L} ( {q}_{2} \vert \vert {q}_{1} ) ) ,$$

where q₁ and q₂ respectively represent the foregoing q1 (a|c) and q2 (a|c), and D_{KL} (q₁∥q₂) represents KL divergence between q₁ and q₂.

For the tagged dialogue data, the basic supervised cross entropy loss is directly used to optimize the dialogue action prediction. Cross entropy is the information used to measure the difference between the two probability distributions. A loss function of this part is denoted as [symbol] _{DA} and may be specifically represented as follows:

[symbol]

_{DA}=−Σᵢ₌₁^{N}{yᵢ log p(aᵢ|c)+(1−yᵢ)log(1−p(aᵢ|c))},

where c represents a context, a represents an action label predicted by the tagged dialogue data DA, a=(a₁, a₂, . . . , a_{N}), N is a total classification quantity of actions labels, and yᵢ∈{0,1} represents a real label of aᵢ.

Finally, for the training of the whole pre-training dialogue model, targets including the dialogue understanding, dialogue policy, and dialogue generation of the entire dialogue model may be added together for the optimization. A total loss function is represented as follows:

[symbol]

ₚᵣₑ= [symbol] _{unlabel}+ [symbol] _{label}

[symbol]

_{unlabel}= [symbol] _{RS}+ [symbol] _{RG}+g [symbol] _{KL}

[symbol]

_{label}= [symbol] _{RS}+ [symbol] _{RG}+ [symbol] _{DA}+ [symbol] _{KL}

In actual application, a large quantity of noise is present in collected untagged data. Therefore, a gate mechanism is used to select high-quality untagged data, which is denoted as g, g∈{0,1} and is specifically denoted as:

$$g = min \{ max \{ 0 , \frac{{E}_{max} - ( E + log E )}{{E}_{max}} \} , 1 \}$$

where, Eₘₐₓ=log N denotes the maximum entropy of the N-dimensional probability scale, E denotes the current entropy of q(a|c), E=Σᵢ^{N}q(aᵢκ)log q(aᵢκ).

Based on the foregoing input and loss functions, training the pre-training dialogue model not only can ensure a sufficient quantity of training samples, but also can incorporate dialogue policy knowledge in label data into the pre-training dialogue model, so as to improve performance of dialogue policy selection in a downstream task, so that the human-machine dialogue system can generate a high-quality response statement and improve interactive experience between the user and the human-machine dialogue system.

In some embodiments of the present disclosure, an output of the foregoing pre-training dialogue model is collectively referred to as a semantic representation without being distinguished in detail.

In addition, to further improve the accuracy of the semantic representation, in some embodiments of the present disclosure, a multi-granularity semantic understanding manner is further used. The semantic feature extraction in a phrase dimension, the semantic feature extraction in a sentence dimension, and the semantic feature extraction in a semantic relationship dimension between multiple turns of dialogues are separately performed by using representation vectors respectively corresponding to the multiple turns of the dialogue data in each dialogue data sample as the input. Semi-supervised training is performed on the pre-training dialogue model based on the extracted semantic feature and the preset semi-supervised loss function. That is, a model is trained from a token dimension, a sentence dimension, and a grammatical relationship dimension between the multiple turns of dialogue data of the dialogue data, to obtain dialogue semantic representations of multiple dimensions, so as to better understand the dialogue semantic by comprehensively considering the semantics of the multiple dimensions.

It should be noted that, in some embodiments of the present disclosure, the pre-training model layer may perform training for extracting and outputting the semantic representation of the dialogue data or the dialogue data sample, so as to subsequently be equipped with the function of outputting the semantic representation. However, for the human-machine dialogue system as a whole, the semantic representation may also be obtained in other ways. For example, after the training of the pre-training dialogue model is completed, parameters of the model may be migrated to a corresponding part of a corresponding model of another layer, so that the part has a function of extracting the semantic representation of the dialogue data, such as a machine learning model of the dialogue construction layer and a machine learning model of the dialogue engine layer. Alternatively, training of a semantic representation function may be directly performed on the machine learning model of the dialogue construction layer and the machine learning model of the dialogue engine layer, so as to implement subsequent extraction and output of the dialogue data representation. However, by using the pre-training the model layer, the training of the function of extracting and outputting a semantic representation is decoupled from other parts, so that a better training effect can be achieved. In addition, the implementation complexity and training costs of other parts can be reduced, and overall creation efficiency of the human-machine dialogue system is improved.

Second, regarding the dialogue construction layer, through the dialogue construction layer, the dialogue procedure can be constructed. A dialogue procedure is also referred to as “taskflow,” and includes a series of sequential dialogue nodes. The dialogue nodes include multiple types, such as a trigger node of a user (expressing a user intention), and a response node of a robot.

In a feasible manner, the construction of the dialogue procedure may be implemented by the following operations. The dialogue construction layer performs dialogue semantic cluster segmentation on the dialogue data sample based on the semantic representation outputted by the pre-training model layer. The semantic representation is configured to characterize the intention of the dialogue data sample. The dialogue construction layer performs hierarchical density clustering according to a semantic cluster obtained by segmentation and a dialogue representation vector corresponding to the dialogue data sample, and obtains, according to the clustering result, at least one start intention and dialogue data corresponding to each start intention. The dialogue construction layer, for each start intention, performs dialogue path mining based on the dialogue data corresponding to the start intention, and obtains, according to a mining result, dialogue semantic clusters respectively corresponding to a user and a robot customer service. The dialogue construction layer constructs a key dialogue transfer matrix according to the dialogue semantic clusters respectively corresponding to the user and the robot customer service. The dialogue construction layer generates, according to the key dialogue transfer matrix, a dialogue path used to indicate a dialogue procedure, and mounts the generated dialogue path to the start intention.

In a specific implementation, as shown in FIG. 3C, a preprocessing, including data cleaning, dialogue statement coding, and dialogue semantic cluster segmentation, may be performed first. The data cleaning may filter out the low-quality voice dialogue data, and may further recognize and filter out the voice dialogue data with the wrong track division. On this basis, coding processing of the dialogue statement and the dialogue semantic cluster segmentation are performed. The dialogue semantic cluster segmentation is based on the semantics of the dialogue statement. In this case, the semantic representation outputted by the pre-training model layer for these dialogue statements may be directly used. Because the semantic representation is an intention representation of the dialogue, the semantic representation may also be considered as an intention of the dialogue data.

In a specific implementation of the dialogue semantic cluster segmentation, a feasible manner is to use a density clustering method, and in this way, semantically similar dialogues are segmented into one cluster.

Then, based on the foregoing preprocessing results, a construction of a dialogue data procedure may be performed. The construction is in an interactive hierarchical form.

After the semantic cluster segmentation is performed, the dialogue data is segmented into multiple semantic clusters. Each semantic cluster may include at least one group of dialogues, and each group of dialogues in each semantic cluster has the same or similar semantic meaning. Therefore, the intention automatic combination is achieved. Further, for each semantic cluster, a start intention may be first discovered by hierarchical mining. Because there may be multiple dialogues expressing different intentions in a group of dialogues, and there is also a sequential process relationship between these dialogues of different intentions, the dialogues of different intentions may be divided into one or more (two or more) layers, and density clustering is performed according to the layers to discover corresponding intentions. The start intention means an intention used to initiate substantive content expression in a dialogue. An example dialogue may be: “Customer service: XXX, hello, I am the customer service of XXX. User: Hello. Customer service: I noticed that you've reserved a standard room at the XXX hotel, but the payment hasn't been made yet. If you still require the room, please make the payment as soon as possible. User: Which hotel are you referring to?” As can be seen from the above dialogue, the intention corresponding to “I noticed that you've reserved a standard room at the XXX hotel, but the payment hasn't been made yet. If you still require the room, please make the payment as soon as possible” is confirmed as a start intention. However, a person skilled in the art should understand that in actual application, the start intention may also be triggered by the user.

Generally, each semantic cluster has a corresponding start intention. Based on this, a node corresponding to each start intention may be constructed. In a feasible manner, a suitable node naming rule may be further set. For example, the node may be directly named using a determined intention or named using a keyword in the intention, thereby implementing automatic naming of the dialogue procedure node. In addition, each start intention belongs to a dialogue, and each start intention needs to be associated with corresponding dialogue data, so as to enter and exit sequent process mining for use.

After the start intention and the dialogue data corresponding to the start intention are determined, the dialogue path mining may be performed on each start intention. In some embodiments of the present disclosure, the dialogue data carries the dialogue turn information and the role information. Based on this, clustering may be performed again to obtain one or more dialogue semantic clusters corresponding to different roles, such as a customer service dialogue cluster and a user dialogue cluster. Further, each turn of dialogues is labeled with the dialogue semantic cluster to which the dialogues belong, and a key dialogue transition matrix that can represent the dialogue semantic transition relationship is constructed based on this. Based on the matrix, a corresponding dialogue path may be generated using a path searching method. Further, after processing, such as a filtering loop, an incomplete path filtering, and a node mergence, performed on the generated dialogue path, the generated complete path is mounted on the node of the current start intention, forming a complete dialogue procedure.

In addition, while process path mining is performed based on the start intention, representative and diverse language techniques for each intention may also be determined from the dialogue data for subsequent intention model training.

However, in an actual application, a large quantity of similar questions need to be manually written for knowledge points or intentions to improve generalization of an intelligent machine response. This process not only requires significant manpower, but is also very time-consuming for writing questions and thus results in a higher cost.

Therefore, in a feasible manner, after a dialogue procedure is constructed at the dialogue construction layer, or after each intention node is determined at the dialogue construction layer, a semantic representation of the dialogue data corresponding to a to-be-expanded intention node may be further obtained. At least one first candidate dialogue data is obtained from an offline generated retrieval database according to the semantic representation, and at least one second candidate dialogue data is generated by using a generation model. The first candidate dialogue data and the second candidate dialogue data are sorted. Quality evaluation is performed on the first candidate dialogue data and the second candidate dialogue data according to a sorting result, and a target dialogue data is determined according to the result of the quality evaluation. Dialogue data expansion (also referred to as intention configuration language technique expansion) is performed on the dialogue data corresponding to the intention node by using the target dialogue data. In this way, the foregoing problem is solved.

In a specific implementation, as shown in FIG. 3D, human-human dialogue data in a human-human log, human-machine dialogue data in a human-machine log, and dialogue data captured from an external (such as a network) may be first obtained by using an offline data mining system, and the dialogue data is preprocessed (including data archiving, data normalization, and data selection, etc.). Pre-processed dialogue data and corresponding semantic vectors of the dialogue data are obtained. Further, an index is constructed for the dialogue data and the semantic vector respectively, and a retrieval database is generated based on the data and the index corresponding to the data.

In another aspect, the dialogue log data may be obtained by using a crowd sourcing system, and the dialogue log data is labeled based on a preset label rule, to obtain label data. By the training based on these label data, a similar question generation model, a sorting model, and a quality model are obtained.

Based on the constructed retrieval database and the foregoing model, a dialogue data expansion can be performed to the dialogue data of a to-be-expanded intention node. As shown in FIG. 3D, the dialogue data of the to-be-expanded intention node is correspondingly processed based on an algorithm platform by a query and analysis module, including performing word segmentation, obtaining a corresponding word vector, performing semantic representation, and performing normalization, etc. Further, based on a processing result of the query and analysis module, a recall module recalls candidate dialogue data (i.e., first candidate dialogue data) from the retrieval database, and generates new candidate dialogue data (i.e., second candidate dialogue data) by using the similar question generation model. The candidate dialogue data may be all sent to the sorting model by the sorting module, so as to perform feature calculation and fusion sorting, to obtain a similarity score indicating the similarity between the dialogue data of the to-be-expanded intention node and the candidate dialogue data. The candidate dialogue data that has been processed by the sorting module to obtain the sorting result is sent to a result filtering and encapsulation module, so that the module performs similarity de-duplication and quality control on the candidate dialogue data by the quality model, and selects the target dialogue data from the candidate dialogue data. The target dialogue data may be used to expand the dialogue data to the dialogue data set corresponding to the intention node. In addition, the target dialogue data may also be written into the log data by the log system for subsequent use.

Therefore, the dialogue data corresponding to the intention can be effectively expanded and enriched, so as to provide a better basis for establishing a dialogue procedure.

It should be further noted that, for some or all of intention nodes, a unknown node may be further set. Therefore, in a later application, when an intention of a dialogue cannot be determined, the unknown node may be matched and fed back to the dialogue engine layer, so that the dialogue engine layer performs subsequent intention clarification processing according to information about the original dialogue.

In addition, a closed-loop function of the model can be set in the dialogue construction layer to implement the functions such as log back-flow labeling, model training evaluation, release, and model effect analysis guiding AIT for effect optimization. For specific implementation thereof, references may be made to descriptions of related technologies, and details are not described herein for brevity.

Third, regarding the dialogue engine layer, a second machine learning model is disposed in the dialogue engine layer.

By the dialogue engine layer, an active dialogue capability of an intelligent machine can be implemented. The intelligent machine can perform dialogue interaction beyond the dialogue procedure constructed by the dialogue construction layer, which is more flexible and intelligent.

A model architecture of the second machine learning model is shown in FIG. 3E, which includes an interactive information collection base part and an interactive information collection system part. The base part is a common resource in various dialogue scenarios, including a pre-training model, a dialogue act system, and a knowledge base (the knowledge base being a common resource in various information collecting scenarios, including digital, Chinese character, and mixed information). The system part is a collection system framework corresponding to various dialogue scenarios, and may be considered as a sub-dialogue system, including four core modules of a general task-type human-machine dialogue system, that is, a dialogue understanding (NLU) module, a dialogue state update (DST) module, a dialogue policy module, and a dialogue generation (NLG) module.

For example, when a dialogue request from the user is received, the dialogue understanding module performs user dialogue behavior (Act) prediction based on a dialogue history and a dialogue request (a “query,” e.g., “My name is Wu Jiaqing, the spelling of Wu is W-U.”). The user dialogue behavior prediction is also referred to a dialogue state prediction. For example, based on a pre-training dialogue model such as a BERT model, prediction space may be 11 types of acts on a user side in the dialogue act system constructed in advance. As shown in the example in the figure, a result of the behavior prediction is “inform” (providing information). Based on the dialogue history, the current query, and the previous dialogue state (Act), the state update module generates the current dialogue state using the DST model. As shown in the example in the figure, the previous dialogue state is null, and a new current dialogue state is generated as “Wu Jiaqing.” The policy prediction module predicts a policy of an interactive information collection system based on the dialogue history and the current dialogue state. Similarly, the pre-training model is used, and the prediction space is eight actions of the system in the dialogue act system constructed in advance. As shown in the example in the figure, a prediction action is to “clarify” the word “Jia.” When the response generation module determines the content to be clarified, for example, “Jia” is a Chinese character, it is necessary to query corresponding knowledge, such as “Jia spelled as J-I-A,” and then query a corresponding clarification template to generate a response, “is Jia spelled as J-I-A?”

For example, the 11 types of acts constructed in advance on the user side are shown in Table 1 below.

TABLE 1

| | User | | |
|---|---|---|---|
| Category | action Act | Abbreviation | Description |
| Information | inform | Providing | Provide information, such |
| maintenance | | number | as “My number is 188”. |
| | ack | Positive | A positive response, |
| | | | including “Okay,” “Uh- |
| | | | huh”. |
| | deny | Negative | Negative response. |
| | update | Update | Update the number, for |
| | | | example, “No, it is 189”. |
| | restart | Restart | Restart, “Let's start from |
| | | | scratch”. |
| Daily action | hello | Say hello | Hello/Hi. |
| | bye | Goodbye | Goodbye, including hang |
| | | | up and end. |
| | wait | Wait | Wait |
| | backchannel | Tone reception | Meaningless expression: |
| | | | “Ah,” “Hmm”. |
| Intelligent | other | Relevant | Within the interactive |
| machine | | | information, other actions, |
| related | | | such as “whose number is |
| | | | this?” |
| | reject | Irrelevant | Beyond the interactive |
| | | | information, other |
| | | | requirements/intentions, |
| | | | such as “I want to check |
| | | | weather”. |

The eight actions constructed in advance are shown in Table 2.

TABLE 2

| Category | System policy | Abbreviation | Description |
|---|---|---|---|
| Information | request | Query | Query a number, such as |
| maintenance | | | “Your phone number |
| | | | please?” |
| | reqmore | And | Continue the speaking, |
| | | | positive expression. |
| | explicit | Explicit | Explicitly clarify “is 188?” |
| | confirm | clarification | and explicitly ask if a |
| | | | number is correct. |
| | req_correct | Ask for | Ask for modification, for |
| | | modification | example, “Where is it |
| | | | wrong?” |
| | restart | All restart | Restart, “let's start over”. |
| Intelligent | reject | Reject | Reject response, “I'm |
| machine | | response | sorry. I don't know about |
| related | | | this”. |
| | final_confirm | Completion | Add completion |
| | | confirmation | confirmation |
| | bye | End of | Information collection |
| | | collection | complete |

Based on the foregoing description, in a feasible manner, the second machine learning model includes a model part (i.e., an NLU module part) configured to perform dialogue state prediction, a model part (i.e., a DST module part) configured to perform dialogue state update, a model part (i.e., a policy module part) configured to perform dialogue response policy prediction, and a model part (i.e., an NLG module part) configured to generate a dialogue response.

Based on this, the dialogue engine layer trains the second machine learning model of the dialogue engine layer based on the semantic representation outputted by the pre-training model layer, so as to obtain the model capable of performing dialogue data collection by following operations: training, based on the semantic representation outputted by the pre-training model layer and a dialogue state label corresponding to the semantic representation, the model part configured to perform dialogue state prediction, so as to obtain a model capable of outputting a current dialogue state; training, based on current dialogue data, the current dialogue state, and another turn of the dialogue data in the multiple turns of the dialogue data, the model part configured to perform dialogue state update, so as to obtain a model capable of outputting an updated dialogue state; training, based on the current dialogue data, the updated dialogue state, and another turn of the dialogue data in the multiple turns of the dialogue data, the model part configured to perform dialogue response policy prediction, so as to obtain a model capable of outputting a dialogue response policy; and training, based on the dialogue response policy and a preset knowledge base, the model part configured to generate the dialogue response, so as to obtain a model capable of outputting the dialogue response.

Training the model part configured to perform dialogue state prediction may be implemented by following operations. Dialogue state prediction training is performed on the classification model part configured to perform dialogue state prediction based on preset dialogue state classification information by using the semantic representation outputted at the pre-training model layer and a dialogue state label corresponding to the semantic representation as an input, so as to obtain a model capable of outputting the current dialogue state. The preset dialogue state classification may be implemented as the 11 classifications shown in Table 1. Certainly, in actual application, a person skilled in the art may also add, delete, or change the classification according to actual requirements.

For example, some user dialogue data such as a user dialogue request and label data of a corresponding action may be labeled. Classification training of the model is performed by using a pre-training model such as BERT or Roberta. In subsequent use, if a user dialogue request is received, the model is used to predict a user action (dialogue state). If the prediction result is “reject” (irrelevant), it indicates that the user dialogue request is not in a complex information collection scenario, and is directly returned to another module in the human-machine dialogue system for processing.

Training the model part configured to perform dialogue state update may be implemented by following operations. multi-task joint training is performed on the model part configured to update a dialogue state based on a segment operation classification task and a bit operation generation task of preset slot information by using the current dialogue data, the current dialogue state, and another turn of dialogue data in the multiple turns of dialogue data as an input, so as to obtain a model capable of outputting an updated dialogue state.

In many dialogue scenarios, a process of updating complex slot information needs to be modeled. To improve modeling efficiency, in some embodiments, modification of the entire complex slot information is divided into two layers: a segment operation and a bit operation. The segment operation performs a whole or block operation on the entire slot information, and the bit operation performs a bitwise operation on the slot information. For example, the segment operation may be abstracted into five categories, that is, all update, all clear, appending content, keeping unchanged, and partially update, and classification modeling is used. The bit operation is entered when the segment operation cannot meet the requirement (when the prediction is partially update) to perform bitwise generation, using a non-autoregressive generation to model, specifically as shown in FIG. 3F.

As can be seen from FIG. 3F, the model input is a dialogue history (History), a dialogue request (Query) of a current user, and a current dialogue state (State), and the output is a new dialogue state. The whole module refines complex slot information into a segment operation and a bit operation to implement fine-grained dialogue state update, based on a model using a transformer structure, such as a pre-training language model BERT or Roberta, which is implemented in a form of multi-task joint modeling of a classification task (segment operation) and a non-autoregressive generation task (bit operation).

Training the model part configured to perform dialogue response policy prediction may be implemented by performing multi-task joint training on the model part configured to perform the dialogue response policy prediction based on a preset response policy prediction task and a task of clarifying and predicting the updated dialogue state by using the current dialogue data, the updated dialogue state, and another turn of the dialogue data in the multiple turns of the dialogue data as an input, so as to obtain the model capable of outputting the dialogue response policy.

The preset response policy prediction task may be the task in Table 2.

It should be noted that, in addition to the prediction of the dialogue response policy, the model further needs to predict a clarification bit of a new dialogue state. The prediction being 0 indicates that by the dialogue history, it is confirmed that there is no question in this part, and no clarification is required. The prediction being 1 indicates that whether a question exists has not been confirmed at present. Therefore, the next-step dialogue interaction with the user is needed to clarify the intention. If the model predicts that no clarification is required, it indicates that the dialogue data collection is completed, returns the entire collected dialogue data, and exits. However, in some cases, the user action category can be used to intervene with rules. For example, when the user action is “wait,” the system action can be directly set to positive, and respond “OK, I'll leave you to it.”, so that the whole human-machine dialogue system provides the ability to achieve good interpretation and intervention.

For example, as shown in FIG. 3G, the model input is a dialogue history (History), a dialogue request (Query) of a current user, and an updated dialogue state (New State), and the output is a dialogue response policy and an indication regarding whether an intention clarification should be performed. In the figure, “Reqmore” is shown, indicating that it is required to continue the dialogue with the user.

Training the model part configured to generate a dialogue response may be implemented by: based on the predicted dialogue response policy, querying a corresponding system language technique template, and generating a system response.

After the dialogue response policy is predicted, the system language technique template under the corresponding policy can be queried to generate the system response. When the predicted action is clarification, the clarifying content is obtained by using the clarification bit. If the clarifying content is a Chinese character, a knowledge base needs to be queried to obtain description content of the Chinese character. For example, if the clarification content is “jia”, the queried description content is “jia spelled as J-I-A”, and a corresponding clarification language technique template is “Is x y?”, where x and y are respectively filled with “Jia” and “Jia spelled as J-I-A”, the generated system response “Is jia the jia spelled as J-I-A?” can be obtained.

By using the foregoing trained model, complex slot information may be collected and maintained by multiple turns of active dialogue interaction, thereby improving the user's intelligent dialogue experience.

Fourth, regarding the voice interaction layer, not only is the content of the dialogue important, but the timing of “when to speak” is also very important. A conventional human-machine dialogue system is limited to a conventional one-question-to-one-answer framework, and has relatively high delay in an interaction process with a user, and cannot exchange information flexibly and quickly as a real person. Therefore, in some embodiments, the voice interaction layer uses a full-duplex dialogue interaction manner based on voice semantic fusion, including three capabilities: tone reception, elegant interruption, and long-pause detection.

First, the tone reception enables the intelligent machine to detect a proper speaking timing and automatically insert a set speech, such as an acknowledgement word, for example, “okay,” “uh-hmm,” or “oh,” which not only reduces a response delay of the intelligent machine during a dialogue, but also improves the fluency of the dialogue. Second, the elegant interruption can correctly reject background noise and noninteractive intention while detecting the user's interrupt intention by the joint modeling of speech and text, and accurately determine the user intention. Finally, an intelligent sentence segmentation is performed by a long-pause detection. If a silence segment has reached a maximum period of interruption, and it is found that the current speech of the user is not complete, a guide language is inserted to guide the user to complete the speech, instead of interrupting the user brutally.

The tone reception function may be implemented by a classification model obtained by training multi-label training data. At least one sample in the multi-label training data has corresponding multiple category labels of set speeches such as acknowledgement words. Multiple category labels of set speeches refer to multiple category labels of at least one sample in a classification task. For example, there may be multiple qualified set speeches (categories/labels) used to insert the dialogues for a sentence spoken by the user. An acknowledgement word is used as an example. For example, an acknowledgement word of a sample is “Hmm. No problem. Thank you.” A corresponding acknowledgement word category label may include labels for multiple categories including “Hmm, okay,” “Okay,” . . . etc. The classification model may use a TextCNN model, an LSTM model, a BERT model, or the like.

Because the model is obtained by training the multi-label training data, when a dialogue meeting an insertion timing for the acknowledgement word is detected, the dialogue is entered into the foregoing trained classification model, to predict and obtain one or more corresponding acknowledgement words. Acknowledgement word insertion is performed according to the predicted acknowledgement word. It can be learned that, by incorporating multiple types of labels into the model, a many-to-many relationship between dialogues triggering an insertion of an acknowledgement word and the acknowledgement word can be well processed, and one or more proper acknowledgement words can be effectively predicted. Then, the acknowledgement word insertion is performed according to the predicted acknowledgement word, so that the human-machine dialogue system is more intelligent, and the user's dialogue experience is improved.

The elegant interruption function may also be obtained by training a corresponding machine learning model. In some embodiments, the model may be obtained in the following manner. The dialogue data sample, and dialogue voice data and noise audio data corresponding to the dialogue data sample are input into a third machine learning model at the voice interaction layer. By using the third machine learning model, features respectively corresponding to the dialogue data sample, the dialogue voice data, and noise audio data are extracted, and the features are and fused to obtain a fusion feature. The third machine learning model is trained based on the fusion feature and preset voice classification, to obtain a model capable of outputting a decision result of an interrupt dialogue.

Specifically, feature extraction may be performed on the dialogue data sample input by using the third machine learning model to obtain a text feature. Feature extraction is performed on the noise audio data and the dialogue voice data after the fusion, to obtain a voice feature. The text feature and the voice feature are combined to obtain the fusion feature. Further, the third machine learning model is trained based on the preset voice classification and the fusion feature. Voice classification may include a type used to represent a user intention corresponding to the dialogue voice data as an interrupt intention, or a type used to represent a non-interrupt intention.

For the long-pause detection function, the aligned voice semantic multi-modal data can be extracted from a large quantity of dialogue data samples for labeling, and the model can learn various long-pause states of the user. To improve the judgment ability of the model, a method that fully fuses the voice and the semantic (that is, combining the voice feature and the text feature) may also be used to achieve more accurate model judgment using inter-modal complementarity. If it is detected that the user dialogue is incomplete and a sentence segmentation is not needed, a guide language can be inserted in the dialogue to guide the user to continue the dialogue, so as to supplement and complete the dialogue. Then, the intelligent machine sends a dialogue response. In this way, the sentence segmentation can be performed more accurately, and erroneous sentence segmentation by the intelligent machine can be effectively prevented, thereby improving the dialogue experience and the efficiency of the human-machine dialogue.

The human-machine dialogue system constructed based on the foregoing process is more intelligent and flexible, and may be widely applied in scenarios involving human-machine dialogue interaction, especially in task-oriented human-machine dialogue scenarios.

According to the human-machine dialogue system constructed in the above embodiments, for human-machine interaction in various fields and industries, a semantic of the human-machine interaction may be analyzed by using a pre-training model layer, then an intention thereof is determined by using a dialogue engine layer to give a corresponding dialogue response accordingly, and then human-machine dialogue interaction is implemented by using a voice interaction layer. It can be learned that the human-machine dialogue system in the embodiments may be widely applied in various scenarios, so that smooth human-machine dialogue interactions can be achieved without human participation, which reduces the construction cost of the human-machine dialogue system and expands the applicable scope of the human-machine dialogue system. In addition, compared with a conventional one-question-to-one-answer human-machine dialogue interaction form, in a case where the human-machine dialogue system fails to obtain the user intention based on the current dialogue, the human-machine dialogue system in the embodiments may further, based on the current dialogue, continue the dialogue with the user on the basis of the original dialogue intention, so as to accurately determine the user intention according to a complete dialogue formed by the original dialogue and the continuous dialogue, and provide an accurate dialogue response. In addition, the user does not need to repeat the previous dialogue or restart the dialogue, which improves the efficiency of human-machine dialogue interaction.

In some embodiments, a human-machine dialogue method is implemented by using the human-machine dialogue system in the embodiments disclosed above. As shown in FIG. 4, the method includes the following steps S402, S404, and S406.

In step S402, a voice dialogue from a user is received by using a voice interaction layer, the voice dialogue is converted into a dialogue text, and then the dialogue text is sent to a dialogue engine layer of a human-machine dialogue system.

In step S404, a semantic representation of the dialogue text is obtained by using a dialogue engine layer of the human-machine dialogue system, intention analysis is performed on the semantic representation, and a dialogue response is determined according to an intention analysis result and a dialogue procedure constructed in advance by a dialogue construction layer.

The dialogue procedure is constructed by using an intention clustering result obtained after the dialogue construction layer performs intention clustering in advance based on the semantic representation of the dialogue data sample. The dialogue response is an answer response to a voice dialogue, or a clarification response to clarify a dialogue intention of a voice dialogue.

In step S406, the dialogue response is converted into voice by using a voice interaction layer, so as to interact with the user by the voice.

The foregoing steps are described briefly. The specific implementation may be performed with reference to the processing of the corresponding part of the human-machine dialogue system in the above embodiments, and details are not repeated herein for brevity.

According to the above embodiments, in different human-machine dialogue scenarios, dialogue procedures in various scenarios may be constructed by offline processing by the dialogue construction layer, which reduces the construction cost of the human-machine dialogue system and expands the applicable scope of the human-machine dialogue system. In addition, in a case where the user intention cannot be obtained based on the current dialogue, the human-machine dialogue system in the embodiments may further, based on the current dialogue, continue the dialogue with the user on the basis of the original dialogue intention, that is, continue the dialogue by using a clarification response, so as to accurately determine the user intention according to a complete dialogue formed by the original dialogue and the continuous dialogue, and provide an accurate dialogue response. In addition, the user does not need to repeat the previous dialogue or restart the dialogue, which improves the efficiency of human-machine dialogue interaction, and improves the user experience.

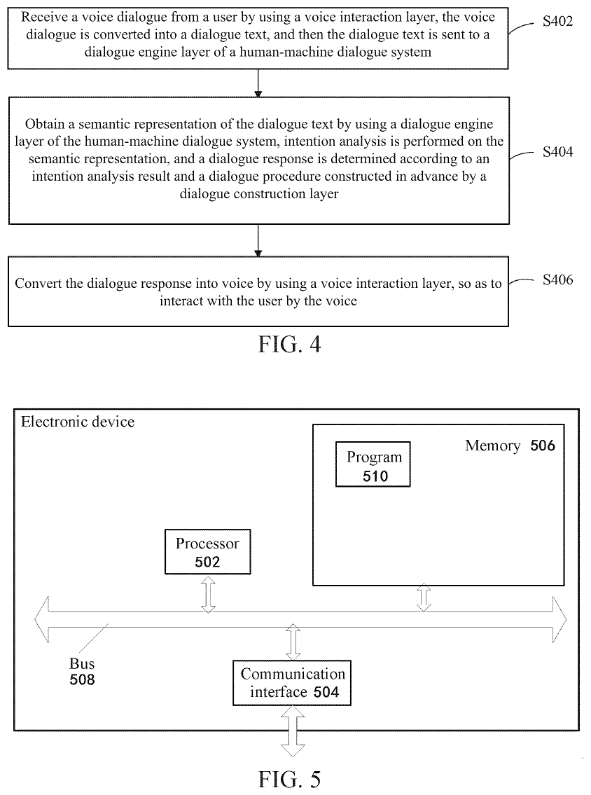

Reference is made to FIG. 5. FIG. 5 is a schematic structural diagram of an electronic device according to some embodiments of the present disclosure. Embodiments of the present disclosure do not limit specific implementations of the electronic device.

As shown in FIG. 5, the electronic device may include a processor 502 (which can be one or more processors), a communication interface 504, a memory 506, and a communication bus 508.

The processor 502, the communication interface 504, and the memory 506 communicate with each other through the communication bus 508.

The communication interface 504 is configured to communicate with another electronic device or a server.

The processor 502 is configured to execute a program 510, and may specifically perform related steps in the foregoing embodiments of the human-machine dialogue method.

Specifically, the program 510 may include program code. The program code includes one or more computer operation instructions.

The processor 502 may be one or more processors such as a CPU, a specific integrated circuit ASIC (Application Specific Integrated Circuit), NPU (neural network processing unit), or one or more integrated circuits configured to implement the embodiments of the present disclosure. One or more processors included in the intelligent device may be processors of the same type, such as one or more CPUs; or may be different types of processors, such as one or more CPUs and one or more ASICs.

The memory 506 is configured to store the human-machine dialogue system and the program 510 described in the foregoing embodiments. The memory 506 may include a high-speed RAM memory, and may further include a non-volatile memory, for example, at least one disk memory.

The program 510 may be specifically used to enable the processor 502 to perform one or more operations corresponding to the human-machine dialogue method described in the foregoing method embodiments. That is, the processor 502 invokes the human-machine dialogue system in the memory 506 according to the human-machine dialogue method described in the foregoing method embodiments, so as to perform corresponding human-machine dialogue interaction operation(s).

For specific implementation of each step performed by the program 510, the reference may be made to the corresponding description in the foregoing method embodiments and in the corresponding steps and units, providing a corresponding beneficial effect. Details are not repeated herein for brevity. It can be clearly understood by a person skilled in the art that, for the purpose of convenient and brief description, for a detailed working process of the foregoing devices and modules, the reference may be made to a corresponding process in the foregoing method embodiments, and details are not repeated herein for brevity.

Some embodiments of the present disclosure further provide a computer program product, including computer instructions. The computer instructions instruct a computing device to perform operation(s) corresponding to the human-machine dialogue method of the method embodiments described above. The embodiments of the present disclosure further provide a non-transitory computer-readable storage medium. The non-transitory computer-readable storage medium stores a set of instructions that are executable by one or more processors of a device to cause the device to perform the operations corresponding to the human-machine dialogue method of the method embodiments described above.

It is noted that, depending on the needs of the implementation, the individual components/steps described in the embodiments of the present disclosure may be split into more components/steps, or two or more components/steps or part of the operations of the components/steps may be combined into a new component/step to achieve the purpose of the embodiments of the present disclosure.

The methods according to the embodiments of the present disclosure described above may be implemented in hardware or firmware, or be implemented as software or computer code that may be stored in a recording medium (such as a CD ROM, RAM, floppy disk, hard disk, or magnetic disk), or be implemented as computer code downloaded over a network that was originally stored in a remote recording medium or non-transitory computer-readable storage medium and will be stored in a local recording medium, such that the methods described herein may be processed by such software stored on a recording medium using a general-purpose computer, a special purpose processor, or programmable or dedicated hardware (such as an ASIC, NPU, FPGA, etc.). It can be understood that the computer, processor, microprocessor controller, or programmable hardware includes a storage component (e.g., RAM, ROM, flash memory, etc.) that can store or receive software or computer code, where the software or computer code, when accessed and executed by the computer, the processor, or the hardware, implements the methods described herein. Further, when a general purpose computer accesses the code used to implement the methods illustrated herein, the execution of the code converts the general purpose computer to a dedicated computer for performing the methods illustrated herein.

Those of ordinary skill in the art can realize that the units and method steps of the examples described in conjunction with the embodiments disclosed herein are capable of being implemented with electronic hardware, or a combination of computer software and electronic hardware. Whether these functions are performed in hardware or software depends on the specific application and design constraints of the technical solution. A skilled professional may use different methods to implement the described functions for each particular application, but such implementations should not be considered outside the scope of the embodiments of the present disclosure.

The embodiments may further be described using the following clauses:
1. A human-machine dialogue system, comprising:
one or more processors configured to execute instructions to cause the human-machine dialogue system to perform operations comprising:
   performing intention clustering of a dialogue data sample based on a semantic representation of the dialogue data sample;
   constructing, based on a clustering result, a dialogue procedure corresponding to the dialogue data sample;
   obtaining a semantic representation corresponding to a voice dialogue of a user;
   performing intention analysis on the semantic representation to obtain an intention analysis result;
   determining, according to the intention analysis result and the dialogue procedure constructed in advance, a dialogue response; and
   performing voice interaction of the dialogue response with the user, wherein the dialogue response is an answer response to the voice dialogue, or a clarification response to clarify a dialogue intention of the voice dialogue.
2. The human-machine dialogue system of clause 1, wherein the operations further comprise:
performing dialogue semantic cluster segmentation on the dialogue data sample in advance based on the semantic representation of the dialogue data sample;
performing hierarchical density clustering according to a semantic cluster obtained by segmentation and a dialogue representation vector corresponding to the dialogue data sample;
obtaining, according to the clustering result, at least one start intention and dialogue data corresponding to each start intention;
for each start intention, performing dialogue path mining based on dialogue data corresponding to the start intention; and
constructing, according to a mining result, a dialogue procedure corresponding to the dialogue data sample.
3. The human-machine dialogue system of clause 2, wherein the dialogue procedure corresponding to the dialogue data sample is constructed according to the mining result by:
obtaining, according to the mining result, dialogue semantic clusters respectively corresponding to a user and a robot customer service corresponding to the dialogue data;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention to construct the dialogue procedure corresponding to the dialogue data sample.
4. The human-machine dialogue system of any of clauses 1-3, wherein the operations further comprise: in a process of performing dialogue interaction with the user, performing at least one of the following operations:
detecting whether an insertion timing for a set speech exists, and inserting the set speech when the insertion timing is detected;
in a process of performing voice dialogue interaction with the user, detecting an inserted voice by the user, and in response to determining that an intention corresponding to the inserted voice is to interrupt a dialogue voice, processing the inserted voice; or
detecting a pause of the user in a dialogue interaction process, and in response to a detection result indicating that a dialogue corresponding to the pause is incomplete, inserting a guide language to guide the user to complete the dialogue.
5. A human-machine dialogue system, comprising:
one or more processors configured to execute instructions to cause the human-machine dialogue system to perform operations comprising:
performing semi-supervised training on a pre-training dialogue model by using obtained dialogue data sample as a training sample of the pre-training dialogue model, to obtain a model capable of outputting a semantic representation corresponding to the dialogue data sample, wherein each dialogue data sample comprises multiple turns of dialogue data, and each turn of the dialogue data comprises role information and turn information;
performing intention clustering on the dialogue data sample based on the semantic representation;
performing dialogue procedure mining based on a result of the intention clustering;
constructing, based on a mining result, a dialogue procedure corresponding to the dialogue data sample;
training a second machine learning model based on the semantic representation, so as to obtain a model capable of making a dialogue response; and
separately training a voice recognition model and a voice conversion model to obtain a corresponding model capable of performing voice recognition and a corresponding model for performing text-to-voice conversion.
6. The human-machine dialogue system of clause 5, wherein one part of the dialogue data sample is tagged data, and the other part of the dialogue data sample is untagged data, and the semi-supervised training on the pre-training dialogue model is performed by using the obtained dialogue data sample as the training sample of the pre-training dialogue model by operations comprising:
determining a representation vector corresponding to each turn of the dialogue data of the dialogue data sample, wherein the representation vector comprises a word representation vector, a role representation vector, a turn representation vector, and a position representation vector; and
performing the semi-supervised training on the pre-training dialogue model based on a preset semi-supervised loss function by using representation vectors respectively corresponding to multiple turns of the dialogue data in each dialogue data sample as an input, wherein the semi-supervised loss function comprises a first sub-loss function for the tagged data and a second sub-loss function for the untagged data.
7. The human-machine dialogue system of clause 6, wherein the first sub-loss function is generated based on a loss function for a dialogue response selection task, a loss function for a dialogue response generation task, a loss function for dialogue action prediction, and a bi-directional KL regularization loss function; and
the second sub-loss function is generated based on the loss function for the dialogue response selection task, the loss function for the dialogue response generation task, and a bi-directional KL regularization loss function with a gate mechanism.
8. The human-machine dialogue system of clause 6 or 7, wherein the semi-supervised training on the pre-training dialogue model is performed based on the preset semi-supervised loss function by using the representation vectors respectively corresponding to the multiple turns of the dialogue data in each dialogue data sample as the input by operations comprising:
separately performing semantic feature extraction in a phrase dimension, semantic feature extraction in a sentence dimension, and semantic feature extraction in a semantic relationship dimension between multiple turns of dialogues by using the representation vectors respectively corresponding to the multiple turns of the dialogue data in each dialogue data sample as the input; and
performing the semi-supervised training on the pre-training dialogue model based on extracted semantic features and the preset semi-supervised loss function.
9. The human-machine dialogue system of any of clauses 6-8, wherein the intention clustering is performed on the dialogue data sample based on the semantic representation, the dialogue procedure mining is performed based on the result of the intention clustering, and the dialogue procedure corresponding to the dialogue data sample is, based on the mining result, constructed by operations comprising:
performing dialogue semantic cluster segmentation on the dialogue data sample based on the semantic representation;
performing hierarchical density clustering according to a semantic cluster obtained by segmentation and a dialogue representation vector corresponding to the dialogue data sample;
obtaining, according to a clustering result, at least one start intention and the dialogue data corresponding to each start intention;
for each start intention, performing dialogue path mining based on the dialogue data corresponding to the start intention;
obtaining, according to a mining result, dialogue semantic clusters respectively corresponding to a user and a robot customer service;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention.
10. The human-machine dialogue system of any of clauses 6-9, wherein the second machine learning model comprises a model part configured to perform dialogue state prediction, a model part configured to perform dialogue state update, a model part configured to perform dialogue response policy prediction, and a model part configured to generate a dialogue response; and
the second machine learning model is trained based on the semantic representation, so as to obtain the model capable of making the dialogue response by operations comprising:
   training, based on the semantic representation and a dialogue state label corresponding to the semantic representation, the model part configured to perform the dialogue state prediction, so as to obtain a model capable of outputting a current dialogue state;
   training, based on current dialogue data, the current dialogue state, and another turn of the dialogue data in the multiple turns of the dialogue data, the model part configured to perform the dialogue state update, so as to obtain a model capable of outputting an updated dialogue state;
   training, based on the current dialogue data, the updated dialogue state, and another turn of the dialogue data in the multiple turns of the dialogue data, the model part configured to perform the dialogue response policy prediction, so as to obtain a model capable of outputting a dialogue response policy; and
   training, based on the dialogue response policy and a preset knowledge base, the model part configured to generate the dialogue response, so as to obtain a model capable of outputting the dialogue response.
11. The human-machine dialogue system of clause 10, wherein the training, based on the current dialogue data, the current dialogue state, and another turn of the dialogue data in the multiple turns of the dialogue data, the model part configured to perform the dialogue state update, so as to obtain the model capable of outputting the updated dialogue state comprises:
performing multi-task joint training on the model part configured to update the dialogue state based on a segment operation classification task and a bit operation generation task of preset slot information by using the current dialogue data, the current dialogue state, and another turn of the dialogue data in the multiple turns of the dialogue data as an input, so as to obtain the model capable of outputting the updated dialogue state.
12. The human-machine dialogue system of clause 10 or 11, wherein the training, based on the current dialogue data, the updated dialogue state, and another turn of the dialogue data in the multiple turns of the dialogue data, the model part configured to perform the dialogue response policy prediction, so as to obtain the model capable of outputting the dialogue response policy comprises:
performing multi-task joint training on the model part configured to perform the dialogue response policy prediction based on a preset response policy prediction task and a task of clarifying and predicting the updated dialogue state by using the current dialogue data, the updated dialogue state, and another turn of the dialogue data in the multiple turns of the dialogue data as an input, so as to obtain the model capable of outputting the dialogue response policy.
13. The human-machine dialogue system of any of clauses 6-12, wherein the operations further comprise:
inputting the dialogue data sample, and dialogue voice data and noise audio data corresponding to the dialogue data sample into a third machine learning model;
extracting, by using the third machine learning model, features respectively corresponding to the dialogue data sample, the dialogue voice data, and the noise audio data, and fusing the features to obtain a fusion feature; and
training the third machine learning model based on the fusion feature and preset voice classification, to obtain a model capable of outputting a decision result of an interrupt dialogue.
14. A non-transitory computer-readable storage medium storing a set of instructions that are executable by one or more processors of a device to cause the device to perform a human-machine dialogue method, wherein the human-machine dialogue method includes operations comprising:
receiving a voice dialogue from a user;
converting the voice dialogue into a dialogue text;
obtaining a semantic representation of the dialogue text;
performing intention analysis on the semantic representation;
determining a dialogue response according to an intention analysis result and a dialogue procedure constructed in advance, wherein the dialogue procedure is constructed by using an intention clustering result obtained after intention clustering is performed in advance based on a semantic representation of a dialogue data sample, and the dialogue response is an answer response to the voice dialogue, or a clarification response to clarify a dialogue intention of the voice dialogue; and
converting the dialogue response into voice, so as to interact with the user by the voice.
15. The non-transitory computer-readable storage medium of clause 14, wherein the operations further comprise:
in a process of performing dialogue interaction with the user, detecting whether an insertion timing for a set speech exists; and
inserting the set speech when the insertion timing is detected.
16. The non-transitory computer-readable storage medium of clause 14 or 15, wherein the operations further comprise:
in a process of performing voice dialogue interaction with the user, detecting an inserted voice by the user; and
in response to determining that an intention corresponding to the inserted voice is to interrupt a dialogue voice, processing the inserted voice.
17. The non-transitory computer-readable storage medium of any of clauses 14-16, wherein operations further comprise:
detecting a pause of the user in a dialogue interaction process; and
in response to a detection result indicating that a dialogue corresponding to the pause is incomplete, inserting a guide language to guide the user to complete the dialogue.
18. The non-transitory computer-readable storage medium of any of clauses 14-17, wherein the dialogue procedure is constructed by:
performing dialogue semantic cluster segmentation on the dialogue data sample in advance based on the semantic representation of the dialogue data sample;
performing hierarchical density clustering according to a semantic cluster obtained by segmentation and a dialogue representation vector corresponding to the dialogue data sample;
obtaining, according to the intention clustering result, at least one start intention and dialogue data corresponding to each start intention;
for each start intention, performing dialogue path mining based on dialogue data corresponding to the start intention; and
constructing, according to a mining result, a dialogue procedure corresponding to the dialogue data sample.
19. The non-transitory computer-readable storage medium of clause 18, wherein the dialogue procedure corresponding to the dialogue data sample is constructed according to the mining result by:
obtaining, according to the mining result, dialogue semantic clusters respectively corresponding to a user and a robot customer service corresponding to the dialogue data;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention to construct the dialogue procedure corresponding to the dialogue data sample.
20. The non-transitory computer-readable storage medium of any of clauses 14-19, wherein one part of the dialogue data sample is tagged data, and the other part of the dialogue data sample is untagged data.
21. A human-machine dialogue method, comprising:
performing intention clustering of a dialogue data sample based on a semantic representation of the dialogue data sample;
constructing, based on a clustering result, a dialogue procedure corresponding to the dialogue data sample;
obtaining a semantic representation corresponding to a voice dialogue of a user;
performing intention analysis on the semantic representation to obtain an intention analysis result;
determining, according to the intention analysis result and the dialogue procedure constructed in advance, a dialogue response; and
performing voice interaction of the dialogue response with the user, wherein the dialogue response is an answer response to the voice dialogue, or a clarification response to clarify a dialogue intention of the voice dialogue.
22. The human-machine dialogue method of clause 21, further comprising:
performing dialogue semantic cluster segmentation on the dialogue data sample in advance based on the semantic representation of the dialogue data sample;
performing hierarchical density clustering according to a semantic cluster obtained by segmentation and a dialogue representation vector corresponding to the dialogue data sample;
obtaining, according to the clustering result, at least one start intention and dialogue data corresponding to each start intention;
for each start intention, performing dialogue path mining based on dialogue data corresponding to the start intention; and
constructing, according to a mining result, a dialogue procedure corresponding to the dialogue data sample.
23. The human-machine dialogue method of clause 22, wherein the dialogue procedure corresponding to the dialogue data sample is constructed according to the mining result by:
obtaining, according to the mining result, dialogue semantic clusters respectively corresponding to a user and a robot customer service corresponding to the dialogue data;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention to construct the dialogue procedure corresponding to the dialogue data sample.
24. The human-machine dialogue method of any of clauses 21-23, further comprising:
in a process of performing dialogue interaction with the user, performing at least one of the following operations:
   detecting whether an insertion timing for a set speech exists, and inserting the set speech when the insertion timing is detected;
   in a process of performing voice dialogue interaction with the user, detecting an inserted voice by the user, and in response to determining that an intention corresponding to the inserted voice is to interrupt a dialogue voice, processing the inserted voice; or
   detecting a pause of the user in a dialogue interaction process, and in response to a detection result indicating that a dialogue corresponding to the pause is incomplete, inserting a guide language to guide the user to complete the dialogue.
25. A human-machine dialogue method, comprising:
performing semi-supervised training on a pre-training dialogue model by using obtained dialogue data sample as a training sample of the pre-training dialogue model, to obtain a model capable of outputting a semantic representation corresponding to the dialogue data sample, wherein each dialogue data sample comprises multiple turns of dialogue data, and each turn of the dialogue data comprises role information and turn information;
performing intention clustering on the dialogue data sample based on the semantic representation;
performing dialogue procedure mining based on a result of the intention clustering;
constructing, based on a mining result, a dialogue procedure corresponding to the dialogue data sample;
training a second machine learning model based on the semantic representation, so as to obtain a model capable of making a dialogue response; and
separately training a voice recognition model and a voice conversion model to obtain a corresponding model capable of performing voice recognition and a corresponding model for performing text-to-voice conversion.
26. The human-machine dialogue method of clause 25, wherein one part of the dialogue data sample is tagged data, and the other part of the dialogue data sample is untagged data, and the semi-supervised training on the pre-training dialogue model is performed by using the obtained dialogue data sample as the training sample of the pre-training dialogue model by operations comprising:
determining a representation vector corresponding to each turn of the dialogue data of the dialogue data sample, wherein the representation vector comprises a word representation vector, a role representation vector, a turn representation vector, and a position representation vector; and
performing the semi-supervised training on the pre-training dialogue model based on a preset semi-supervised loss function by using representation vectors respectively corresponding to multiple turns of the dialogue data in each dialogue data sample as an input, wherein the semi-supervised loss function comprises a first sub-loss function for the tagged data and a second sub-loss function for the untagged data.
27. The human-machine dialogue method of clause 26, further comprising:
generating the first sub-loss function based on a loss function for a dialogue response selection task, a loss function for a dialogue response generation task, a loss function for dialogue action prediction, and a bi-directional KL regularization loss function; and
generating the second sub-loss function based on the loss function for the dialogue response selection task, the loss function for the dialogue response generation task, and a bi-directional KL regularization loss function with a gate mechanism.
28. The human-machine dialogue method of clause 26 or 27, wherein the semi-supervised training on the pre-training dialogue model is performed based on the preset semi-supervised loss function by using the representation vectors respectively corresponding to the multiple turns of the dialogue data in each dialogue data sample as the input by operations comprising:
separately performing semantic feature extraction in a phrase dimension, semantic feature extraction in a sentence dimension, and semantic feature extraction in a semantic relationship dimension between multiple turns of dialogues by using the representation vectors respectively corresponding to the multiple turns of the dialogue data in each dialogue data sample as the input; and
performing the semi-supervised training on the pre-training dialogue model based on extracted semantic features and the preset semi-supervised loss function.
29. The human-machine dialogue method of any of clauses 26-28, wherein the intention clustering is performed on the dialogue data sample based on the semantic representation, the dialogue procedure mining is performed based on the result of the intention clustering, and the dialogue procedure corresponding to the dialogue data sample is, based on the mining result, constructed by operations comprising:
performing dialogue semantic cluster segmentation on the dialogue data sample based on the semantic representation;
performing hierarchical density clustering according to a semantic cluster obtained by segmentation and a dialogue representation vector corresponding to the dialogue data sample;
obtaining, according to a clustering result, at least one start intention and the dialogue data corresponding to each start intention;
for each start intention, performing dialogue path mining based on the dialogue data corresponding to the start intention;
obtaining, according to a mining result, dialogue semantic clusters respectively corresponding to a user and a robot customer service;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention.
30. The human-machine dialogue method of any of clauses 26-29, wherein the second machine learning model comprises a model part configured to perform dialogue state prediction, a model part configured to perform dialogue state update, a model part configured to perform dialogue response policy prediction, and a model part configured to generate a dialogue response; and
the second machine learning model is trained based on the semantic representation, so as to obtain the model capable of making the dialogue response by operations comprising:
   training, based on the semantic representation and a dialogue state label corresponding to the semantic representation, the model part configured to perform the dialogue state prediction, so as to obtain a model capable of outputting a current dialogue state;
   training, based on current dialogue data, the current dialogue state, and another turn of the dialogue data in the multiple turns of the dialogue data, the model part configured to perform the dialogue state update, so as to obtain a model capable of outputting an updated dialogue state;
   training, based on the current dialogue data, the updated dialogue state, and another turn of the dialogue data in the multiple turns of the dialogue data, the model part configured to perform the dialogue response policy prediction, so as to obtain a model capable of outputting a dialogue response policy; and
   training, based on the dialogue response policy and a preset knowledge base, the model part configured to generate the dialogue response, so as to obtain a model capable of outputting the dialogue response.
31. The human-machine dialogue method of clause 30, wherein the training, based on the current dialogue data, the current dialogue state, and another turn of the dialogue data in the multiple turns of the dialogue data, the model part configured to perform the dialogue state update, so as to obtain the model capable of outputting the updated dialogue state comprises:
performing multi-task joint training on the model part configured to update the dialogue state based on a segment operation classification task and a bit operation generation task of preset slot information by using the current dialogue data, the current dialogue state, and another turn of the dialogue data in the multiple turns of the dialogue data as an input, so as to obtain the model capable of outputting the updated dialogue state.
32. The human-machine dialogue method of clause 30 or 31, wherein the training, based on the current dialogue data, the updated dialogue state, and another turn of the dialogue data in the multiple turns of the dialogue data, the model part configured to perform the dialogue response policy prediction, so as to obtain the model capable of outputting the dialogue response policy comprises:
performing multi-task joint training on the model part configured to perform the dialogue response policy prediction based on a preset response policy prediction task and a task of clarifying and predicting the updated dialogue state by using the current dialogue data, the updated dialogue state, and another turn of the dialogue data in the multiple turns of the dialogue data as an input, so as to obtain the model capable of outputting the dialogue response policy.
33. The human-machine dialogue method of any of clauses 26-32, further comprising:
inputting the dialogue data sample, and dialogue voice data and noise audio data corresponding to the dialogue data sample into a third machine learning model;
extracting, by using the third machine learning model, features respectively corresponding to the dialogue data sample, the dialogue voice data, and the noise audio data, and fusing the features to obtain a fusion feature; and
training the third machine learning model based on the fusion feature and preset voice classification, to obtain a model capable of outputting a decision result of an interrupt dialogue.
34. A human-machine dialogue method, comprising:
receiving a voice dialogue from a user;
converting the voice dialogue into a dialogue text;
obtaining a semantic representation of the dialogue text;
performing intention analysis on the semantic representation;
determining a dialogue response according to an intention analysis result and a dialogue procedure constructed in advance, wherein the dialogue procedure is constructed by using an intention clustering result obtained after intention clustering is performed in advance based on a semantic representation of a dialogue data sample, and the dialogue response is an answer response to the voice dialogue, or a clarification response to clarify a dialogue intention of the voice dialogue; and
converting the dialogue response into voice, so as to interact with the user by the voice.
35. The human-machine dialogue method of clause 34, further comprising:
in a process of performing dialogue interaction with the user, detecting whether an insertion timing for a set speech exists; and
inserting the set speech when the insertion timing is detected.
36. The human-machine dialogue method of clause 34 or 35, further comprising:
in a process of performing voice dialogue interaction with the user, detecting an inserted voice by the user; and
in response to determining that an intention corresponding to the inserted voice is to interrupt a dialogue voice, processing the inserted voice.
37. The human-machine dialogue method of any of clauses 34-36, further comprising:
detecting a pause of the user in a dialogue interaction process; and
in response to a detection result indicating that a dialogue corresponding to the pause is incomplete, inserting a guide language to guide the user to complete the dialogue.
38. The human-machine dialogue method of any of clauses 34-37, wherein the dialogue procedure is constructed by:
performing dialogue semantic cluster segmentation on the dialogue data sample in advance based on the semantic representation of the dialogue data sample;
performing hierarchical density clustering according to a semantic cluster obtained by segmentation and a dialogue representation vector corresponding to the dialogue data sample;
obtaining, according to the intention clustering result, at least one start intention and dialogue data corresponding to each start intention;
for each start intention, performing dialogue path mining based on dialogue data corresponding to the start intention; and
constructing, according to a mining result, a dialogue procedure corresponding to the dialogue data sample.
39. The human-machine dialogue method of clause 38, wherein the dialogue procedure corresponding to the dialogue data sample is constructed according to the mining result by:
obtaining, according to the mining result, dialogue semantic clusters respectively corresponding to a user and a robot customer service corresponding to the dialogue data;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention to construct the dialogue procedure corresponding to the dialogue data sample.
40. The human-machine dialogue method of any of clauses 34-39, wherein one part of the dialogue data sample is tagged data, and the other part of the dialogue data sample is untagged data.

The above implementation is only for the purpose of illustrating the embodiments of the present disclosure, and is not a limitation of the embodiments of the present disclosure. A person of ordinary skill in the art concerned may make various variations and variants without departing from the spirit and scope of the embodiments of the present disclosure, so that all equivalent technical solutions also fall within the scope of the embodiments of the present disclosure, and the scope of patent protection of the embodiments of the present disclosure shall be limited by the claims.

What is claimed is:

1. A human-machine dialogue system, comprising:
one or more processors configured to execute instructions to cause the human-machine dialogue system to perform operations comprising:
performing intention clustering of a dialogue data sample based on a semantic representation of the dialogue data sample;
constructing, based on a clustering result, a dialogue procedure corresponding to the dialogue data sample;
obtaining a semantic representation corresponding to a voice dialogue of a user;
performing intention analysis on the semantic representation to obtain an intention analysis result;
determining, according to the intention analysis result and the dialogue procedure constructed in advance, a dialogue response; and
performing voice interaction of the dialogue response with the user, wherein the dialogue response is an answer response to the voice dialogue, or a clarification response to clarify a dialogue intention of the voice dialogue.

2. The human-machine dialogue system of claim 1, wherein the operations further comprise:
performing dialogue semantic cluster segmentation on the dialogue data sample in advance based on the semantic representation of the dialogue data sample;
performing hierarchical density clustering according to a semantic cluster obtained by segmentation and a dialogue representation vector corresponding to the dialogue data sample;
obtaining, according to the clustering result, at least one start intention and dialogue data corresponding to each start intention;
for each start intention, performing dialogue path mining based on dialogue data corresponding to the start intention; and
constructing, according to a mining result, a dialogue procedure corresponding to the dialogue data sample.

3. The human-machine dialogue system of claim 2, wherein the dialogue procedure corresponding to the dialogue data sample is constructed according to the mining result by:
obtaining, according to the mining result, dialogue semantic clusters respectively corresponding to a user and a robot customer service corresponding to the dialogue data;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention to construct the dialogue procedure corresponding to the dialogue data sample.

4. The human-machine dialogue system of claim 1, wherein the operations further comprise: in a process of performing dialogue interaction with the user, performing at least one of the following operations:
detecting whether an insertion timing for a set speech exists, and inserting the set speech when the insertion timing is detected;
in a process of performing voice dialogue interaction with the user, detecting an inserted voice by the user, and in response to determining that an intention corresponding to the inserted voice is to interrupt a dialogue voice, processing the inserted voice; or
detecting a pause of the user in a dialogue interaction process, and in response to a detection result indicating that a dialogue corresponding to the pause is incomplete, inserting a guide language to guide the user to complete the dialogue.

5. A human-machine dialogue system, comprising:
one or more processors configured to execute instructions to cause the human-machine dialogue system to perform operations comprising:
performing semi-supervised training on a pre-training dialogue model by using obtained dialogue data sample as a training sample of the pre-training dialogue model, to obtain a model capable of outputting a semantic representation corresponding to the dialogue data sample, wherein each dialogue data sample comprises multiple turns of dialogue data, and each turn of the dialogue data comprises role information and turn information;
performing intention clustering on the dialogue data sample based on the semantic representation;
performing dialogue procedure mining based on a result of the intention clustering;
constructing, based on a mining result, a dialogue procedure corresponding to the dialogue data sample;
training a second machine learning model based on the semantic representation, so as to obtain a model capable of making a dialogue response; and
separately training a voice recognition model and a voice conversion model to obtain a corresponding model capable of performing voice recognition and a corresponding model for performing text-to-voice conversion.

6. The human-machine dialogue system of claim 5, wherein one part of the dialogue data sample is tagged data, and the other part of the dialogue data sample is untagged data, and the semi-supervised training on the pre-training dialogue model is performed by using the obtained dialogue data sample as the training sample of the pre-training dialogue model by operations comprising:
determining a representation vector corresponding to each turn of the dialogue data of the dialogue data sample, wherein the representation vector comprises a word representation vector, a role representation vector, a turn representation vector, and a position representation vector; and
performing the semi-supervised training on the pre-training dialogue model based on a preset semi-supervised loss function by using representation vectors respectively corresponding to multiple turns of the dialogue data in each dialogue data sample as an input, wherein the semi-supervised loss function comprises a first sub-loss function for the tagged data and a second sub-loss function for the untagged data.

7. The human-machine dialogue system of claim 6, wherein the first sub-loss function is generated based on a loss function for a dialogue response selection task, a loss function for a dialogue response generation task, a loss function for dialogue action prediction, and a bi-directional KL regularization loss function; and
the second sub-loss function is generated based on the loss function for the dialogue response selection task, the loss function for the dialogue response generation task, and a bi-directional KL regularization loss function with a gate mechanism.

8. The human-machine dialogue system of claim 6, wherein the semi-supervised training on the pre-training dialogue model is performed based on the preset semi-supervised loss function by using the representation vectors respectively corresponding to the multiple turns of the dialogue data in each dialogue data sample as the input by operations comprising:
separately performing semantic feature extraction in a phrase dimension, semantic feature extraction in a sentence dimension, and semantic feature extraction in a semantic relationship dimension between multiple turns of dialogues by using the representation vectors respectively corresponding to the multiple turns of the dialogue data in each dialogue data sample as the input; and
performing the semi-supervised training on the pre-training dialogue model based on extracted semantic features and the preset semi-supervised loss function.

9. The human-machine dialogue system of claim 6, wherein the intention clustering is performed on the dialogue data sample based on the semantic representation, the dialogue procedure mining is performed based on the result of the intention clustering, and the dialogue procedure corresponding to the dialogue data sample is, based on the mining result, constructed by operations comprising:
performing dialogue semantic cluster segmentation on the dialogue data sample based on the semantic representation;
performing hierarchical density clustering according to a semantic cluster obtained by segmentation and a dialogue representation vector corresponding to the dialogue data sample;
obtaining, according to a clustering result, at least one start intention and the dialogue data corresponding to each start intention;
for each start intention, performing dialogue path mining based on the dialogue data corresponding to the start intention;
obtaining, according to a mining result, dialogue semantic clusters respectively corresponding to a user and a robot customer service;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention.

10. The human-machine dialogue system of claim 6, wherein the second machine learning model comprises a model part configured to perform dialogue state prediction, a model part configured to perform dialogue state update, a model part configured to perform dialogue response policy prediction, and a model part configured to generate a dialogue response; and
the second machine learning model is trained based on the semantic representation, so as to obtain the model capable of making the dialogue response by operations comprising:
training, based on the semantic representation and a dialogue state label corresponding to the semantic representation, the model part configured to perform the dialogue state prediction, so as to obtain a model capable of outputting a current dialogue state;
training, based on current dialogue data, the current dialogue state, and another turn of the dialogue data in the multiple turns of the dialogue data, the model part configured to perform the dialogue state update, so as to obtain a model capable of outputting an updated dialogue state;
training, based on the current dialogue data, the updated dialogue state, and another turn of the dialogue data in the multiple turns of the dialogue data, the model part configured to perform the dialogue response policy prediction, so as to obtain a model capable of outputting a dialogue response policy; and
training, based on the dialogue response policy and a preset knowledge base, the model part configured to generate the dialogue response, so as to obtain a model capable of outputting the dialogue response.

11. The human-machine dialogue system of claim 10, wherein the training, based on the current dialogue data, the current dialogue state, and another turn of the dialogue data in the multiple turns of the dialogue data, the model part configured to perform the dialogue state update, so as to obtain the model capable of outputting the updated dialogue state comprises:
performing multi-task joint training on the model part configured to update the dialogue state based on a segment operation classification task and a bit operation generation task of preset slot information by using the current dialogue data, the current dialogue state, and another turn of the dialogue data in the multiple turns of the dialogue data as an input, so as to obtain the model capable of outputting the updated dialogue state.

12. The human-machine dialogue system of claim 10, wherein the training, based on the current dialogue data, the updated dialogue state, and another turn of the dialogue data in the multiple turns of the dialogue data, the model part configured to perform the dialogue response policy prediction, so as to obtain the model capable of outputting the dialogue response policy comprises:
performing multi-task joint training on the model part configured to perform the dialogue response policy prediction based on a preset response policy prediction task and a task of clarifying and predicting the updated dialogue state by using the current dialogue data, the updated dialogue state, and another turn of the dialogue data in the multiple turns of the dialogue data as an input, so as to obtain the model capable of outputting the dialogue response policy.

13. The human-machine dialogue system of claim 6, wherein the operations further comprise:
inputting the dialogue data sample, and dialogue voice data and noise audio data corresponding to the dialogue data sample into a third machine learning model;
extracting, by using the third machine learning model, features respectively corresponding to the dialogue data sample, the dialogue voice data, and the noise audio data, and fusing the features to obtain a fusion feature; and
training the third machine learning model based on the fusion feature and preset voice classification, to obtain a model capable of outputting a decision result of an interrupt dialogue.

14. A non-transitory computer-readable storage medium storing a set of instructions that are executable by one or more processors of a device to cause the device to perform a human-machine dialogue method, wherein the human-machine dialogue method includes operations comprising:
receiving a voice dialogue from a user;
converting the voice dialogue into a dialogue text;
obtaining a semantic representation of the dialogue text;
performing intention analysis on the semantic representation;
determining a dialogue response according to an intention analysis result and a dialogue procedure constructed in advance, wherein the dialogue procedure is constructed by using an intention clustering result obtained after intention clustering is performed in advance based on a semantic representation of a dialogue data sample, and the dialogue response is an answer response to the voice dialogue, or a clarification response to clarify a dialogue intention of the voice dialogue; and
converting the dialogue response into voice, so as to interact with the user by the voice.

15. The non-transitory computer-readable storage medium of claim 14, wherein the operations further comprise:
in a process of performing dialogue interaction with the user, detecting whether an insertion timing for a set speech exists; and
inserting the set speech when the insertion timing is detected.

16. The non-transitory computer-readable storage medium of claim 14, wherein the operations further comprise:
in a process of performing voice dialogue interaction with the user, detecting an inserted voice by the user; and
in response to determining that an intention corresponding to the inserted voice is to interrupt a dialogue voice, processing the inserted voice.

17. The non-transitory computer-readable storage medium of claim 14, wherein operations further comprise:
detecting a pause of the user in a dialogue interaction process; and
in response to a detection result indicating that a dialogue corresponding to the pause is incomplete, inserting a guide language to guide the user to complete the dialogue.

18. The non-transitory computer-readable storage medium of claim 14, wherein the dialogue procedure is constructed by:
performing dialogue semantic cluster segmentation on the dialogue data sample in advance based on the semantic representation of the dialogue data sample;
performing hierarchical density clustering according to a semantic cluster obtained by segmentation and a dialogue representation vector corresponding to the dialogue data sample;
obtaining, according to the intention clustering result, at least one start intention and dialogue data corresponding to each start intention;
for each start intention, performing dialogue path mining based on dialogue data corresponding to the start intention; and
constructing, according to a mining result, a dialogue procedure corresponding to the dialogue data sample.

19. The non-transitory computer-readable storage medium of claim 18, wherein the dialogue procedure corresponding to the dialogue data sample is constructed according to the mining result by:
obtaining, according to the mining result, dialogue semantic clusters respectively corresponding to a user and a robot customer service corresponding to the dialogue data;
constructing a key dialogue transfer matrix according to the dialogue semantic clusters respectively corresponding to the user and the robot customer service;
generating, according to the key dialogue transfer matrix, a dialogue path used to indicate a dialogue procedure; and
mounting the generated dialogue path to the start intention to construct the dialogue procedure corresponding to the dialogue data sample.

20. The non-transitory computer-readable storage medium of claim 14, wherein one part of the dialogue data sample is tagged data, and the other part of the dialogue data sample is untagged data.
